(19) United States
(12) Patent Application Publication
(10) Pub. No.: US 2026/0167559 A1
(43) Pub. Date: Jun. 18, 2026

(54) BASALT COMPOSITIONS HAVING LOW GLASS TRANSITION TEMPERATURE AND HIGH MODULUS FOR GLASS FIBER APPLICATIONS

(71) Applicant: CORNING INCORPORATED, CORNING, NY (US)

(72) Inventors: Dane Alphanso Christie, Painted Post, NY (US); Adam Robert Sarafian, Corning, NY (US); Emily Kathryn Sarafian, Corning, NY (US)

(21) Appl. No.: 19/243,929

(22) Filed: Jun. 20, 2025

Related U.S. Application Data
(60) Provisional application No. 63/664,857, filed on Jun. 27, 2024.

(51) Int. Cl. C03C 3/087

(52) U.S. Cl. CPC C03C 3/087

(57) ABSTRACT

A composition includes from 35 wt. % to 60 wt. % SiO₂; from 7 wt. % to 20 wt. % Al₂O₃; from 7 wt. % to 24 wt. % iron oxides; from 8 wt. % to 20 wt. % CaO; from 1 wt. % to 5 wt. % alkali metal oxides; and from 0.5 wt. % to 12 wt. % B₂O₃ based on the total weight of the composition. Continuous basalt fibers having the composition exhibit low glass transition temperature and high modulus and are suitable for glass fiber applications.

### CROSS-REFERENCE TO RELATED APPLICATION

This application claims the benefit of priority under 35 U.S.C. § 119 of U.S. Provisional Application Ser. No. 63/664,857 filed on Jun. 27, 2024, the content of which is relied upon and incorporated herein by reference in its entirety.

### BACKGROUND

### Field

The present specification generally relates to glass compositions, in particular, to continuous basalt fibers.

### Technical Background

High-modulus, high-strength fibers have strong longitudinal stiffness but remain flexible due to their small diameter. These fibers are used to make stiff composite materials in a flexible form factor across a range of industries including aerospace, defense, architectural, automotive, and energy generation, among others. Silicate glass fiber is a commonly used high-modulus, high-strength material, of which E-glass represents a commodity variant. It has lower manufacturing costs than other synthetic fibers, such as carbon fiber. However, specialty glass fibers designed to have industry-leading modulus or strength, such as R-glass, S-glass, and their derivatives, are more expensive to produce due to the expensive rare earth element raw materials, and high melting and forming temperatures.

### SUMMARY

Accordingly, an ongoing need exists for glass compositions and continuous basalt fibers, as well as batch compositions for making the continuous basalt fibers, that have reduced melt temperatures as well as mechanical properties comparable or improved relative to existing commercially-available glass fibers. According to a first aspect disclosed herein, a composition may comprise from 35 wt. % to 60 wt. % SiO₂; from 7 wt. % to 20 wt. % Al₂O₃; from 7 wt. % to 24 wt. % iron oxides; from 8 wt. % to 20 wt. % CaO; from 1 wt. % to 5 wt. % alkali metal oxides; and from 0.5 wt. % to 12 wt. % B₂O₃, wherein the weight percentages are based on the total weight of the composition.

A second aspect disclosed herein may include the first aspect, further comprising from 2 wt. % to 20 wt. % MgO based on the total weight of the composition.

A third aspect disclosed herein may include either one of the first or second aspects, further comprising from 0.1 wt. % to 3 wt. % TiO₂ based on the total weight of the composition.

A fourth aspect disclosed herein may include any one of the first through third aspects, further comprising from 0.1 wt. % to 1 wt. % MnO₂ based on the total weight of the composition.

A fifth aspect disclosed herein may include any one of the first through fourth aspects, wherein: the iron oxides include FeO, Fe₂O₃, or both; and the alkali metal oxides comprise Na₂O, K₂O, or both.

A sixth aspect disclosed herein may include any one of the first through fifth aspects, wherein the composition may have a melt temperature of from 1200° C. to less than 1500° C., such as from 1200° C. to 1490° C.

A seventh aspect disclosed herein may include any one of the first through sixth aspects, wherein the composition may have a glass transition temperature of from 600° C. to 700° C.

An eighth aspect disclosed herein may include any one of the first through seventh aspects, wherein the composition may have a difference between a glass transition temperature and a crystallization temperature of from 100° C. to 220° C., where the crystallization temperature refers to the temperature at which crystallization of the composition begins as measured by differential scanning calorimetry (DSC).

A ninth aspect disclosed herein may include any one of the first through eighth aspects, wherein the composition may have a density of from 2.7 g/cm³ to 3.2 g/cm³.

A tenth aspect disclosed herein may include any one of the first through ninth aspects, wherein the composition may comprise from 36 wt. % to 52.0 wt. % SiO₂; from 11.5 wt. % to 18.5 wt. % Al₂O₃; from 7.5 wt. % to 20 wt. % iron oxides; from 3 wt. % to 8 wt. % MgO; from 0.5 wt. % to 2 wt. % TiO₂; from 10 wt. % to 15 wt. % CaO; from 1.8 wt. % to 4.2 wt. % alkali metal oxides; and from 2 wt. % to 9 wt. % B₂O₃, wherein the weight percentages are based on the total weight of the composition.

An eleventh aspect disclosed herein may include any one of the first through ninth aspects, wherein the composition may comprise: from 44 mol % to 60 mol % SiO₂; from 7 mol % to 15 mol % Al₂O₃; from 3 mol % to 11 mol % iron oxides; from 10 mol % to 20 mol % CaO; from 1 mol % to 5 mol % alkali metal oxides; and from 0.5 mol % to 12 mol % B₂O₃, wherein the mole percentages are based on a total moles of oxides in the composition.

A twelfth aspect disclosed herein may include any one of the first through eleventh aspects, further comprising from 1 ppbw to 5 ppmw uranium.

A thirteenth aspect disclosed herein may include any one of the first through twelfth aspects, further comprising from 1 ppbw to 5 ppmw thorium.

A fourteenth aspect disclosed herein may include any one of the first through thirteenth aspects, wherein the composition does not contain any purposely added fining agents, where the purposely added fining agents are selected from the group consisting of SnO₂, As₂O₃, Sb₂O₃, CeO₂, F, Cl, and Br.

A fifteenth aspect disclosed herein may include any one of the first through fourteenth aspects, wherein the composition may comprise less than 0.01 mol % fining agents based on the total moles of oxide in the composition, where the fining agents are selected from the group consisting of SnO₂, As₂O₃, Sb₂O₃, CeO₂, F, Cl, and Br.

A sixteenth aspect disclosed herein may include any one of the first through fifteenth aspects, wherein the composition may be in the form of a continuous basalt fiber.

A seventeenth aspect disclosed herein may include the sixteenth aspect, wherein the continuous basalt fiber may have a Young's Modulus of greater than or equal to 85 GPa, such as from 85 GPa to 120 GPa, or from 90 GPa to 120 GPa.

An eighteenth aspect disclosed herein may include either one of the sixteenth or seventeenth aspects, wherein the continuous basalt fiber may have a Young's modulus that is within 10 GPa of a Young's modulus of a comparative basalt fiber made with basalt only with no added colemanite or other constituents, wherein a basalt used to make the continuous basalt fiber and the basalt used to make the comparative basalt fiber are from the same source.

A nineteenth aspect disclosed herein may include any one of the sixteenth through eighteenth aspects, wherein the continuous basalt fiber may have a tensile strength of greater than or equal to 1000 MPa, such as from 1000 MPa to 1200 MPa.

A twentieth aspect disclosed herein may include any one of the sixteenth through nineteenth aspects, wherein the continuous basalt fiber may have a Shear Modulus of greater than or equal to 35 GPa, such as from 35 GPa to 50 GPa, or from 35 GPa to 45 GPa.

A twenty-first aspect disclosed herein may include any one of the sixteenth through twentieth aspects, wherein the continuous basalt fiber may have a melt temperature that is at least 20° C. less than a melt temperature of a comparative basalt fiber made with basalt only with no added colemanite or other constituents, wherein a basalt used to make the continuous basalt fiber and the basalt used to make the comparative basalt fiber are from the same source.

A twenty-second aspect disclosed herein may include any one of the sixteenth through twenty-first aspects, wherein the continuous basalt fiber may have a glass transition temperature that is at least 20° C. less than a glass transition temperature of a comparative basalt fiber made with basalt only with no added colemanite or other constituents, wherein a basalt used to make the continuous basalt fiber and the basalt used to make the comparative basalt fiber are from the same source.

A twenty-third aspect disclosed herein may include any one of the sixteenth through twenty-second aspects, and may be directed to an article comprising the continuous basalt fibers of any one of the sixteenth through twenty-second aspects.

A twenty-fourth aspect disclosed herein may include the twenty-third aspect, wherein the article may be a composite article.

A twenty-fifth aspect disclosed herein may include either one of the twenty-third or twenty-fourth aspects, wherein the article may comprise a hard disk substrate, a wind turbine blade, a pressurized tank, a building material, insulation, an aircraft structure, a spacecraft structure, electronics packaging, or sporting goods.

A twenty-sixth aspect disclosed herein may include any one of the first through fifteenth aspects, wherein the composition may comprise a batch composition.

A twenty-seventh aspect disclosed herein may include the twenty-sixth aspect, wherein the batch composition may comprise from 75 wt. % to 99.5 wt. % basalt and from 0.5 wt. % to 25 wt. % colemanite, based on the total weight of the composition.

A twenty-eighth aspect disclosed herein may include the twenty-seventh aspect, wherein the colemanite may comprise greater than or equal to 90 wt. % hydrated calcium borate, such as from 90 wt. % to 100 wt. % hydrated calcium borate.

A twenty-ninth aspect disclosed herein may include any one of the twenty-sixth through twenty-eighth aspects, and may be directed to a continuous basalt fiber made from the batch composition of any one of the twenty-sixth through twenty-eighth aspects, wherein the continuous basalt fiber may have a Young's Modulus of greater than or equal to 85 GPa, such as from 85 GPa to 120 GPa, or from 90 GPa to 120 GPa.

A thirtieth aspect disclosed herein may be directed to a method of making a continuous basalt fiber. The method may comprise combining from 75 wt. % to 99.5 wt. % basalt with from 0.5 wt. % to 25 wt. % colemanite to produce a batch composition; heating the batch composition to a forming temperature of from 1200° C. to 1400° C. to produce a melt; drawing a continuous strand from the melt; and cooling the continuous strand to produce the continuous basalt fiber.

A thirty-first aspect disclosed herein may include the thirtieth aspect, wherein the batch composition may comprise: from 35 wt. % to 60 wt. % SiO₂; from 7 wt. % to 20 wt. % Al₂O₃; from 7 wt. % to 24 wt. % iron oxides; from 8 wt. % to 20 wt. % CaO; from 1 wt. % to 5 wt. % alkali metal oxides; and from 0.5 wt. % to 12 wt. % B₂O₃, wherein the weight percentages are based on the total weight of the composition.

A thirty-second aspect disclosed herein may include the thirty-first aspect, wherein the batch composition further may comprise from 2 wt. % to 20 wt. % MgO based on the total weight of the batch composition.

A thirty-third aspect disclosed herein may include any one of the thirty-first or thirty-second aspects, wherein the batch composition further may comprise from 0.1 wt. % to 3 wt. % TiO₂ based on the total weight of the batch composition.

A thirty-fourth aspect of the present disclosure may include any one of the thirtieth through thirty-third aspects, comprising a continuous basalt fiber produced from the method of any one of the thirtieth through thirty-third aspects.

A thirty-fifth aspect comprises a combination of any two or more preceding aspects or any portion(s) thereof.

Additional features and advantages of the compositions and methods disclosed herein will be set forth in the detailed description, which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

FIG. 1 graphically depicts a difference between crystallization temperature and glass transition temperature (Tₓ-T_{g}) (y-axis) as a function of glass transition temperature (x-axis) for commercially-available glass fibers and continuous basalt fibers, according to one or more aspects shown and described herein;

FIG. 2 graphically depicts a difference between crystallization temperature and glass transition temperature (Tₓ-T_{g}) (y-axis) as a function of B₂O₃ mole percent (mol %) (x-axis) for commercially-available glass fibers and continuous basalt fibers, according to one or more aspects shown and described herein;

FIG. 3 graphically depicts Young's modulus in GPa (y-axis) as a function of the different between crystallization temperature and glass transition temperature (Tₓ-T_{g}) (x-axis) for commercially-available glass fibers and continuous basalt fibers, according to one or more aspects shown and described herein;

FIG. 4 graphically depicts Young's modulus in GPa (y-axis) as a function of the glass transition temperature (T_{g}) (x-axis) for commercially-available glass fibers and continuous basalt fibers, according to one or more aspects shown and described herein;

FIG. 5 graphically depicts Young's modulus in GPa (y-axis) as a function of density (x-axis) for commercially-available glass fibers and continuous basalt fibers, according to one or more aspects shown and described herein; and

FIG. 6 graphically depicts temperature (y-axis) as a function of B₂O₃ content (x-axis) for the melt temperature and liquidus temperature for commercially-available glass fibers and continuous basalt fibers, according to one or more aspects shown and described herein.

### DESCRIPTION

Reference will now be made in detail to aspects of the compositions, continuous basalt fibers, and methods of producing continuous basalt fibers of the present disclosure, examples of which are illustrated in the accompanying drawings. Whenever possible, the same reference numerals will be used throughout the drawings to refer to the same or like parts. Aspects of the present disclosure are directed to compositions which may be used for continuous basalt fibers. The composition may comprise from 35 wt. % to 60 wt. % silica (SiO₂), from 7 wt. % to 20 wt. % alumina (Al₂O₃), from 7 wt. % to 24 wt. % iron oxides (e.g., FeO, Fe₂O₃, etc.), from 8 wt. % to 20 wt. % calcium oxide (CaO), from 1 wt. % to 5 wt. % alkali metal oxides (e.g., Na₂O, K₂O, etc.), and from 0.5 wt. % to 12 wt. % boric oxide (B₂O₃), where the weight percentages are based on a unit weight of the composition. In aspects, the composition may include other constituents, such as but not limited to magnesium oxide (MgO), titanium dioxide (TiO₂), manganese oxide (MnO₂), or combinations thereof.

The present disclosure may also include the continuous basalt fibers having the composition, batch compositions, and methods for making the continuous basalt fibers disclosed herein. The batch compositions may comprise basalt and boron compounds, such as colemanite, which primarily comprises hydrated calcium borate. The addition of the boron, such as through addition of colemanite or other boron oxide precursors, may reduce the melt temperature of the batch composition while not compromising the strength of the continuous basalt fibers produced therefrom compared to continuous basalt fibers prepared from compositions comprising only basalt.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of aspects described in the specification.

Directional terms as used herein—for example up, down, right, left, front, back, top, bottom—are made only with reference to the figures as drawn and the coordinate axis provided therewith and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

Where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

As used herein, the phrase “on an oxide basis” when used in conjunction with a mol % means that the basis of the mol % is the total moles of the metal oxide molecules in the composition. The phrase “on an oxide basis” when used in conjunction with a batch composition means the components when converted to oxides (e.g., CaCO₃ may be part of the batch composition, but upon heating converts to CaO).

As previously discussed, high-modulus, high-strength fibers have a strong longitudinal stiffness but remain flexible due to their small diameter. These fibers are used to make stiff composite materials in a flexible form factor across a range of industries. Silicate glass fiber, of which E-glass represents a commodity variant, has lower manufacturing costs compared to other synthetic fibers, such as carbon fiber. However, specialty glass fibers designed to have industry-leading modulus or strength, such as R-glass, S-glass, and their derivatives, are more expensive to produce due to the expensive rare earth element raw materials needed and high melting and forming temperatures required. Compositions for E-glass, R-glass, and S-glass are provided in the Examples Section.

Continuous basalt fibers (CBF) are another high-modulus, high-strength fiber material, with mechanical properties comparable or improved relative to commercially-available specialty glass fibers, such as E-glass, R-glass, and S-glass fibers. Basalt is a naturally formed, extrusive igneous (volcanic) rock composed of Si—Al—Ca—Mg—Na—K—Ti-and Fe. Over 90% of all volcanic rock on Earth is basalt, and there are many basalt deposits throughout the world. Basalt fibers have improved chemical corrosion resistance over other glass fibers, are easier to recycle, and the abundant natural source material does not require energy-intensive processing, resulting in low raw materials cost. Despite these benefits, industry has been slow to adopt the use of CBF because current production volumes are too low, raising the final price point too high for widespread use.

Acidic CBF have high concentrations of SiO₂, which provide for the high mechanical properties of the fiber, such as greater strength. However, processing these acidic basalt compositions is very challenging. Acidic basalt compositions are more viscous, have higher melting temperatures (i.e., Tₘ˜1400-1650° C.), and similarly higher forming temperatures (i.e., T_{f}˜1300-1550° C.), compared to traditional E-glass fibers, which have Tₘ 1345-1460° C. and T_{f} 1180-1280° C. High forming temperatures are required because basalts have a high crystallization temperature and high crystallization rate. In addition, the high iron contents of basalts (e.g., 8 wt. % to 16 wt. % iron oxides) means that the melt absorbs more energy compared to a more conventional glass fiber composition. This poor heat permeability means it takes more time and energy to uniformly heat a basalt batch composition to produce a melt. Therefore, large-scale, high-efficiency production of CBF is currently not commercially feasible largely because the manufacturing of basalt fibers requires too high energy inputs.

Continuous basalt fibers are desirable for their superior performance relative to silicate glass fibers and minimal raw material processing requirements. However, the high melting and forming temperatures of basalts limits their wide-scale usage. Therefore, a need exists for continuous basalt fibers having compositions with reduced melting and forming temperatures while also preserving the strength and other mechanical properties of the continuous basalt fibers.

One method of modifying the melt temperatures and/or forming temperatures of glass compositions is to modify the chemical composition of the glass by introducing additives. However, addition of a pure component to aid melting, such as boron compounds, can increase the raw material costs dramatically and can negatively affect the crystallization temperature and/or mechanical properties of the glass composition. The composition of continuous basalt fibers can be modified to improve strength through introduction of additives, such as alumina (Al₂O₃) and/or silica (SiO₂), for example. However, these strength improving additives adversely affect the meltability of the compositions. For instance, addition of alumina to a batch material for producing continuous basalt fibers can increase the strength of the resulting basalt fibers, but also increases the melting temperature, making it more difficult and costly to uniformly heat the preform. Addition of silica to the batch material can also improve the strength of the continuous basalt fibers, but when the SiO₂ content exceeds about 57 wt %, the glass melt becomes too viscous to homogenize during melting all while increasing the melting temperature. In some aspects, however, it is desirable to introduce additives including relatively pure components.

The present disclosure solves various problems in the manufacture of continuous basalt fibers by combining basalt with a boron source, such as but not limited to colemanite, which was found to reduce the melting temperature while also maintaining the strength and other mechanical properties of the continuous basalt fibers. In aspects, the boron source may be colemanite, which is a naturally occurring hydrated calcium borate mineral, Ca₂BO₁₁·5H₂O, that occurs throughout the world. The colemanite is an abundant and inexpensive raw material. The batch composition for making the continuous basalt fibers and the continuous basalt fibers themselves disclosed herein can include from 0.5 wt. % to 25 wt. % colemanite. The continuous basalt fibers disclosed herein can include from 75 wt. % to 99.5 wt. % basalt and from 0.5 wt. % to 25 wt. % colemanite based on a unit weight of the continuous basalt fibers. In aspects, other boron precursors, such as pure calcium borate or other boron containing precursors, may also be used in the batch compositions for forming the compositions of the continuous basalt fibers.

In the technical field of glass manufacturing, it is known that the addition of boron to a glass composition reduces the melting temperature of the glass composition, but calcium and boron are also known to reduce glass modulus and impact crystallization temperature. Surprisingly, the it was found that the addition of colemanite, which includes both boron and calcium, to the basalt resulted in only a minimal reduction in Young's modulus (e.g., reduction in less than 6 GPa) of the continuous basalt fiber with a dramatic reduction in melting temperature (e.g., reduction of up to 200° C.) of the continuous basalt fiber of the present disclosure compared to fibers made from basalt alone. Additionally, an improvement in glass stability was also observed for the continuous basalt fibers disclosed herein compared to fibers made from basalt only.

The technical result of mixing colemanite with the basalt is to improve the manufacturability of continuous basalt fibers without sacrificing the mechanical properties of the final continuous basalt fibers. The raw materials (e.g., basalt and colemanite) are earth abundant and do not require any significant pre-processing prior to making the continuous basalt fibers. This reduces energy and raw material costs. The basalt and colemanite in mineral form are sustainable raw materials with reduced CO₂ footprints compared to traditional purified batch raw materials, such as processed precursors for Ca, Mg, Na, Si, Al, and other batched elements.

Colemanite lowers the melting temperature of the batch composition without sacrificing the strength of the continuous basalt fibers made therefrom. Without being bound by any particular theory, it is believed that the colemanite acts as a flux to lower the basalt melting temperature so that less energy is required to uniformly heat and homogenize the batch composition to produce a melt from which the continuous basalt fiber can be drawn. A more homogeneous melt produces higher quality continuous basalt fibers. The impact on crystallization temperature shows a wider glass stability for the inventive compositions which allows for a wider range of forming temperatures. Finally, the Young's modulus of the continuous basalt fibers remains high. This allows for the production of high modulus (e.g., 85-99 GPa) to ultra-high modulus (e.g., ≥100 GPa) continuous basalt fibers at processing temperatures similar to a low temperature specialty fibers, such as E-glass fibers. Additionally, since iron in the basalt acts as a fining agent, the continuous basalt fibers and compositions disclosed herein do not require any added fining agents, which are typically expensive and/or contain rare elements, such as but not limited to Sn or Ce. The continuous basalt fibers and batch compositions disclosed herein also do not require sulfate fining, which can emit toxic gases like SOₛ that need to be captured at a capture efficiency sufficient to meet environmental standards, among other features. In some aspects, the compositions disclosed herein may contain one or more fining agents.

As previously discussed, in some aspects the composition of the continuous basalt fibers disclosed herein are made from a batch composition comprising basalt and colemanite. Basalt refers to a naturally formed, extrusive igneous (volcanic) rock that comprises oxides of silicon (Si), aluminum (Al), calcium (Ca), magnesium (Mg), sodium (Na), potassium (K), titanium (Ti), and iron (Fe), and potentially other constituents. Over 90% of all volcanic rock on Earth is basalt, and there are many basalt deposits throughout the world. Each basalt source may have a unique chemistry with weight percentages of oxides from all sources generally falling within the ranges of from 42 wt. % to 58 wt. % SiO₂, from 0.5 wt. % to 2 wt. % TiO₂, from 8 wt. % to 20 wt. % Al₂O₃, from 8 wt. % to 16 wt. % iron oxides (e.g., FeO, Fe₂O₃, other iron oxides or combinations thereof), from 4 wt. % to 22 wt. % MgO, from 7 wt. % to 16 wt. % CaO, and from 1 wt. % to 5 wt % Na₂O+K₂O, the weight percentages being based on a unit weight of the basalt. Basalts can be classified by SiO₂ content as alkaline (e.g., less than or equal to 42 wt. % SiO₂), mildly acidic (e.g., from 43 wt. % to 46 wt. % SiO₂), or acidic (e.g., greater than 46 wt. % SiO₂). In some aspects, continuous basalt fibers have improved chemical corrosion resistance over other glass fibers, are easier to recycle, and the abundant natural source material does not require energy-intensive processing resulting in low raw materials cost. The batch compositions for making the continuous basalt fibers disclosed herein may include from 75 wt. % to 99.5 wt. % of the basalt based on the total weight of the batch composition for making the continuous basalt fibers.

Colemanite is a naturally occurring hydrated calcium borate mineral, which can be represented by the formula Ca₂B₆O₁₁·5H₂O. The batch compositions for making the continuous basalt fibers may include from 0.5 wt. % to 25 wt. % of the colemanite based on the total weight of the batch composition.

The continuous basalt fibers disclosed herein may comprise the oxides present in or derived from the constituents of the basalt and colemanite included in the batch composition. In particular, the continuous basalt fibers may include SiO₂, Al₂O₃, iron oxides (e.g., FeO, Fe₂O₃, etc.), CaO, alkali metal oxides (e.g., Na₂O, K₂O, etc.), and B₂O₃. In aspects, the continuous basalt fibers may also include MgO, TiO₂, MnO₂, or combinations thereof. Being formed from raw materials comprising naturally occurring rocks, the continuous basalt fibers may also include trace elements, such as phosphorous, uranium, thorium, and other elements found in naturally-occurring rocks but not typically present in pre-processed and relatively pure batch materials. The components of the continuous basalt fibers can be derived from basalt, colemanite, and/or individual batched components (e.g., in a relatively pure form). In aspects, the composition of the continuous basalt fibers may comprise from 35 wt. % to 60 wt. % SiO₂, from 7 wt. % to 20 wt. % Al₂O₃, from 7 wt. % to 24 wt. % iron oxides, from 8 wt. % to 20 wt. % CaO, from 1 wt. % to 5 wt. % alkali metal oxides, and from 0.5 wt. % to 12 wt. % B₂O₃, wherein the weight percentages are based on a unit weight of the composition.

SiO₂ is the primary constituent of the continuous basalt fibers and may function to stabilize the amorphous glass-like network structure of the continuous basalt fibers. The concentration of SiO₂ in the composition of the continuous basalt fibers affects the strength of the continuous basalt fibers as well as the melt temperature and viscosity of the melt formed from the batch composition during manufacturing of the continuous basalt fiber. For instance, greater concentrations of SiO₂ can improve the mechanical properties of the continuous basalt fibers, such as Young's modulus, tensile strength, or other mechanical property. However, greater SiO₂ concentrations can also increase the melting temperature and the viscosity of the melt, which may make it more difficult to melt the materials and produce the continuous basalt fibers from the melt. Thus, the concentration of SiO₂ in the composition of the continuous basalt fiber should be sufficiently high to provide acceptable mechanical properties, but not so high that the melt temperature and viscosity of the melt make it difficult to draw the continuous basalt fiber from the melt.

The composition of the continuous basalt fibers may comprise from 35 wt. % to 60 wt. % of the SiO₂ per unit weight of the composition. In aspects, the composition of the continuous basalt fibers may comprise from 35 wt. % to 55 wt. %, from 35 wt. % to 52 wt. %, from 35 wt. % to 50 wt. %, from 35 wt. % to 38 wt. %, from 36 wt. % to 60 wt. %, from 36 wt. % to 55 wt. %, from 36 wt. % to 52 wt. %, from 36 wt. % to 50 wt. %, from 38 wt. % to 60 wt. %, from 38 wt. % to 55 wt. %, from 38 wt. % to 52 wt. %, from 38 wt. % to 50 wt. %, or from 50 wt. % to 60 wt. %, or any and all sub-ranges formed from any of the endpoints of these ranges, of the SiO₂ based on the unit weight of the composition. When the concentration of the SiO₂ in the composition of the continuous basalt fiber is less than 35 wt. %, the continuous basalt fiber may have reduced strength. When the concentration of the SiO₂ in the composition of the continuous basalt fiber is greater than 60 wt. %, the batch composition used to make the continuous basalt fiber may have a melt temperature and melt viscosity that are too high to allow for efficient production of the continuous basalt fibers.

The composition of the continuous basalt fibers may be expressed on a moles of oxide basis. In aspects, the composition of the continuous basalt fibers may comprise, on an oxide basis, greater than or equal to 42 mol % and less than or equal to 60 mol % of the SiO₂. In aspects, the continuous basalt fibers may comprise, on an oxide basis, from 42 mol % to 57 mol %, from 42 mol % to 55 mol %, from 42 mol % to 46 mol %, from 44 mol % to 60 mol %, from 44 mol % to 57 mol %, from 44 mol % to 55 mol %, from 44 mol % to 46 mol %, from 46 mol % to 60 mol %, from 46 mol % to 57 mol %, or from 46 mol % to 55 mol %, or any and all sub-ranges formed from any of the endpoints of these ranges, of the SiO₂ based on the total moles per unit volume of the composition.

Like SiO₂, Al₂O₃ may also stabilize the glass network and additionally may improve the mechanical properties, such as tensile strength and/or modulus, and chemical durability of the resulting continuous basalt fibers. However, the concentration of the Al₂O₃ in the composition may also affect the melt temperature of the continuous basalt fiber during manufacturing, such as by increasing the melt temperature of the batch composition, which may increase the energy costs required to produce a homogeneous melt. Al₂O₃ may be contributed to the composition of the continuous basalt fiber by the basalt raw material, colemanite raw material, and/or by addition as an individual component.

The composition of the continuous basalt fibers may comprise from 7 wt. % to 20 wt. % of the Al₂O₃ per unit weight of the composition. In aspects, the composition of the continuous basalt fibers may comprise from 7 wt. % to 20 wt. %, from 7 wt. % to 19 wt. %, from 7 wt. % to 18.5 wt. %, from 7 wt. % to 11.5 wt. %, from 10 wt. % to 20 wt. %, from 10 wt. % to 19 wt. %, from 10 wt. % to 18.5 wt. %, from 10 wt. % to 11.5 wt. %, from 11 wt. % to 20 wt. %, from 11 wt. % to 19 wt. %, from 11 wt. % to 18.5 wt. %, from 11.5 wt. % to 20 wt. %, or from 11.5 wt. % to 19 wt. %, from 11.5 wt. % to 18.5 wt. %, from 18.5 wt. % to 20 wt. %, or any and all sub-ranges formed from any of the endpoints of these ranges, of the Al₂O₃ based on the unit weight of the composition. When the concentration of the Al₂O₃ in the composition of the continuous basalt fibers is less than 7 wt. %, the composition and continuous basalt fibers made therefrom may have reduced mechanical properties, such as reduced tensile strength and/or reduced modulus. When the concentration of the Al₂O₃ in the compositions of the continuous basalt fiber is greater than 20 wt. %, the batch composition used to make the continuous basalt fiber may have an increased melt temperature that may increase the energy requirement for producing a homogeneous melt.

The composition of the continuous basalt fibers may be expressed on a moles of oxide basis. In aspects, the composition of the continuous basalt fibers may comprise, on an oxide basis, greater than or equal to 7 mol % and less than or equal to 15 mol % of the Al₂O₃. In aspects, the composition of the continuous basalt fibers may comprise, on an oxide basis, from 7 mol % to 13.5 mol %, from 7.5 mol % to 15 mol %, from 7.5 mol % to 13.5 mol %, from 13.5 mol % to 15 mol %, or any and all sub-ranges formed from any of the endpoints of these ranges, of the Al₂O₃ based on the total moles of oxide per unit volume of the composition.

Iron may be contributed to the composition of the continuous basalt fiber by the basalt raw material and/or by addition as an individual component. The iron oxides may include FeO, Fe₂O₃, other iron oxides, or combinations of iron oxides. The iron oxides may act as fining agents in the melt to remove gas bubbles from the melt prior drawing the continuous basalt fibers. Additionally, the presence of iron oxides can increase the heat capacity of the batch composition, which may cause the batch composition, during manufacturing, to absorb additional heat energy. The greater the concentration of iron oxides in the composition of the continuous basalt fiber, the greater the energy needed to increase the temperature of the batch composition to the melt temperature during production of the continuous basalt fibers. Thus, increased concentration of iron oxides may increase the time and energy required to produce the melt from the batch composition during manufacturing of the continuous basalt fibers.

The composition of the continuous basalt fibers may comprise from 7 wt. % to 24 wt. % of the iron oxides per unit weight of the composition. In aspects, the composition of the continuous basalt fibers may comprise from 7 wt. % to 22 wt. %, from 7 wt. % to 20 wt. %, from 7 wt. % to 15 wt. %, from 7 wt. % to 8 wt. %, from 7.5 wt. % to 24 wt. %, from 7.5 wt. % to 22 wt. %, from 7.5 wt. % to 20 wt. %, from 7.5 wt. % to 15 wt. %, from 7.5 wt. % to 8 wt. %, from 8 wt. % to 24 wt. %, from 8 wt. % to 22 wt. %, from 8 wt. % to 20 wt. %, from 8 wt. % to 15 wt. %, from 15 wt. % to 24 wt. %, from 15 wt. % to 22 wt. %, from 15 wt. % to 20 wt. %, from 20 wt. % to 24 wt. %, from 20 wt. % to 22 wt. %, from 22 wt. % to 24 wt. %, or any and all sub-ranges formed from any of the endpoints of these ranges, of the iron oxides per unit weight of the composition.

The composition of the continuous basalt fibers may be expressed on a moles of oxide basis. In aspects, the composition of the continuous basalt fibers may comprise, on an oxide basis, greater than or equal to 3 mol % and less than or equal to 11 mol % of the iron oxides. In aspects, the composition of the continuous basalt fibers may comprise, on an oxide basis, from 3 mol % to 11 mol %, from 3 mol % to 10 mol %, from 3 mol % to 9 mol %, from 3 mol % to 5 mol %, from 3.5 mol % to 11 mol %, from 3.5 mol % to 10 mol %, from 3.5 mol % to 9 mol %, from 3.5 mol % to 5 mol %, from 4 mol % to 11 mol %, from 4 mol % to 10 mol %, from 4 mol % to 9 mol %, from 5 mol % to 11 mol %, from 5 mol % to 10 mol %, from 5 mol % to 9 mol %, from 9 mol % to 11 mol %, or any and all sub-ranges formed from any of the endpoints of these ranges, of the iron oxides based on the total moles of oxides per unit volume of the composition.

The composition of the continuous basalt fibers may comprise CaO. The CaO may be present in the basalt and may also be contributed by the colemanite, and/or CaO may be contributed to the composition as CaO or in a form that produces CaO (e.g., CaCO₃). The presence of calcium, in the form of calcium oxides, in glass compositions has been shown to reduce the Young's modulus of glass compositions and also may impact the crystallization temperature of glass compositions. Despite the elevated concentrations of CaO in the composition of the continuous basalt fibers disclosed herein (e.g., from 8 wt. % to 20 wt. %) resulting from the inclusion of the colemanite and/or as an individual component, it was found that the use of a CaO source, such as the colemanite, showed only a minimal reduction (i.e., <6 GPa) in the Young's modulus of the continuous basalt fibers compared to basalt fibers made without the colemanite or other CaO source.

The composition of the continuous basalt fibers disclosed herein may comprise from 8 wt. % to 20 wt. % of the CaO per unit weight of the composition. In aspects, the composition of the continuous basalt fibers may comprise from 8 wt. % to 18 wt. %, from 8 wt. % to 15 wt. %, from 8 wt. % to 14.5 wt. %, from 8 wt. % to 14 wt. %, from 8 wt. % to 10 wt. %, from 9 wt. % to 20 wt. %, from 9 wt. % to 18 wt. %, from 9 wt. % to 15 wt. %, from 9 wt. % to 14.5 wt. %, from 9 wt. % to 14 wt. %, from 10 wt. % to 20 wt. %, from 10 wt. % to 18 wt. %, from 10 wt. % to 15 wt. %, from 10 wt. % to 14.5 wt. %, from 10 wt. % to 14 wt. %, from 14 wt. % to 20 wt. %, from 14 wt. % to 18 wt. %, from 14.5 wt. % to 20 wt. %, from 14.5 wt. % to 18 wt. %, from 15 wt. % to 20 wt. %, from 15 wt. % to 18 wt. %, from 18 at. % to 20 wt. %, or any and all sub-ranges formed from any of the endpoints of these ranges, of the CaO per unit weight of the composition.

The composition of the continuous basalt fibers may be expressed on a moles of oxide basis. In aspects, the composition of the continuous basalt fibers may comprise, on an oxide basis, greater than or equal to 10 mol % and less than or equal to 20 mol % of the CaO. In aspects, the composition of the continuous basalt fibers may comprise, on an oxide basis, from 10 mol % to 20 mol %, from 10 mol % to 19 mol %, from 10 mol % to 17 mol %, from 10 mol % to 13 mol %, from 11 mol % to 20 mol %, from 11 mol % to 19 mol %, from 11 mol % to 17 mol %, from 11 mol % to 13 mol %, from 13 mol % to 20 mol %, from 13 mol % to 19 mol %, from 13 mol % to 17 mol %, from 17 mol % to 20 mol %, from 17 mol % to 19 mol %, from 19 mol % to 20 mol %, or any and all sub-ranges formed from any of the endpoints of these ranges, of the iron oxides based on the total moles of oxide per unit volume of the composition.

The composition of the continuous basalt fibers may also include alkali metal oxides, which may be contributed by the basalt raw material and/or may be added as an individual component. In aspects, the alkali metal oxides may be selected from the group consisting of Li₂O, Na₂O, K₂O, Rb₂O, Cs₂O, and combinations thereof. In aspects, the alkali metal oxides may be selected from the group consisting of Na₂O, K₂O, and combinations thereof. In aspects, the alkali metal oxides may be Na₂O and K₂O. The presence of the alkali metal oxides in the composition of the continuous basalt fibers may reduce the liquidus temperature of the continuous basalt fibers and improve the meltability of the batch composition used to make the continuous basalt fibers. If the concentration of alkali metal oxides, specifically Na₂O, K₂O, or both, is too low, then the meltability of the batch composition may be reduced and the continuous basalt fibers may not be able to be drawn from the melt during production.

The composition of the continuous basalt fibers disclosed herein may comprise from 1 wt. % to 5 wt. % of the alkali metal oxides per unit weight of the composition. In aspects, the composition of the continuous basalt fibers may comprise from 1 wt. % to 4.5 wt. %, from 1 wt. % to 4.2 wt. %, from 1 wt. % to 4 wt. %, from 1.5 wt. % to 5 wt. %, from 1.5 wt. % to 4.5 wt. %, from 1.5 wt. % to 4.2 wt. %, from 1.5 wt. % to 4 wt. %, from 1.8 wt. % to 5 wt. %, from 1.8 wt. % to 4.5 wt. %, from 1.8 wt. % to 4.2 wt. %, from 1.8 wt. % to 4 wt. %, from 4 wt. % to 5 wt. %, from 4 wt. % to 4.5 wt. %, from 4.2 wt. % to 5 wt. %, or any and all sub-ranges formed from any of the endpoints of these ranges, of the alkali metal oxides per unit weight of the composition. In aspects, the alkali metal oxides in the composition of the continuous basalt fibers may comprise Na₂O and K₂O. In aspects, the composition of the continuous basalt fibers may comprise from 1 wt. % to 5 wt. %, from 1 wt. % to 4.5 wt. %, from 1 wt. % to 4.2 wt. %, from 1 wt. % to 4 wt. %, from 1.5 wt. % to 5 wt. %, from 1.5 wt. % to 4.5 wt. %, from 1.5 wt. % to 4.2 wt. %, from 1.5 wt. % to 4 wt. %, from 1.8 wt. % to 5 wt. %, from 1.8 wt. % to 4.5 wt. %, from 1.8 wt. % to 4.2 wt. %, from 1.8 wt. % to 4 wt. %, from 4 wt. % to 5 wt. %, from 4 wt. % to 4.5 wt. %, from 4.2 wt. % to 5 wt. %, or any and all sub-ranges formed from any of the endpoints of these ranges, of [Na₂O+K₂O] per unit weight of the composition.

The composition of the continuous basalt fibers may be expressed on a moles of oxide basis. In aspects, the composition of the continuous basalt fibers may comprise, on an oxide basis, greater than or equal to 1 mol % and less than or equal to 5 mol % of the alkali metal oxides. In aspects, the composition of the continuous basalt fibers may comprise, on an oxide basis, from 1 mol % to 5 mol %, from 1 mol % to 4 mol %, from 1 mol % to 3.5 mol %, from 1 mol % to 2.5 mol %, from 1 mol % to 2 mol %, from 1.5 mol % to 5 mol %, from 1.5 mol % to 4 mol %, from 1.5 mol % to 3.5 mol %, from 1.5 mol % to 2.5 mol %, from 1.5 mol % to 2 mol %, from 2 mol % to 5 mol %, from 2 mol % to 4 mol %, from 2 mol % to 3.5 mol %, from 2 mol % to 3 mol %, from 2.5 mol % to 5 mol %, from 2.5 mol % to 4 mol %, from 2.5 mol % to 3.5 mol %, from 3.5 mol % to 5 mol %, from 4 mol % to 5 mol %, or any and all sub-ranges formed from any of the endpoints of these ranges, of the alkali metal oxides based on the total moles of oxide per unit volume of the composition. In aspects, the composition of the continuous basalt fibers may comprise, on an oxide basis, from 1 mol % to 5 mol %, from 1 mol % to 4 mol %, from 1 mol % to 3.5 mol %, from 1 mol % to 2.5 mol %, from 1 mol % to 2 mol %, from 1.5 mol % to 5 mol %, from 1.5 mol % to 4 mol %, from 1.5 mol % to 3.5 mol %, from 1.5 mol % to 2.5 mol %, from 1.5 mol % to 2 mol %, from 2 mol % to 5 mol %, from 2 mol % to 4 mol %, from 2 mol % to 3.5 mol %, from 2 mol % to 3 mol %, from 2.5 mol % to 5 mol %, from 2.5 mol % to 4 mol %, from 2.5 mol % to 3.5 mol %, from 3.5 mol % to 5 mol %, from 4 mol % to 5 mol %, or any and all sub-ranges formed from any of the endpoints of these ranges, of the [Na₂O+K₂O] based on the total moles of oxides per unit volume of the composition.

As previously discussed, the composition of the continuous basalt fibers further include B₂O₃, which may be primarily contributed by the colemanite raw material and/or added as an individual component. The presence of boron in the composition of the continuous basalt fibers may reduce the melt temperature of the continuous basalt fibers, which may improve the ability to make a homogeneous melt at a reduced temperature (e.g., reduction in melt temperature of up to of even exceeding 200° C., depending on the amount of boron oxide in the batch composition) compared to pure basalt fibers. The presence of boron in glass compositions has been known to reduce the Young's modulus and lower the crystallization temperatures. However, it was found that, by using colemanite as the raw material providing the boron oxide, the resulting continuous basalt fibers exhibited only a minimal reduction in the Young's modulus (i.e., <6 GPa) compared to basalt fibers made from basalt without the colemanite, while reducing the melt temperature by from 30° C. to 225° C. compared to basalt fibers made without colemanite.

The composition of the continuous basalt fibers disclosed herein may comprise from 0.5 wt. % to 12 wt. % of the B₂O₃ per unit weight of the composition. In aspects, the composition of the continuous basalt fibers may comprise from 0.5 wt. % to 10 wt. %, from 0.5 wt. % to 9 wt. %, from 0.5 wt. % to 8 wt. %, from 0.5 wt. % to 2 wt. %, from 1 wt. % to 12 wt. %, from 1 wt. % to 10 wt. %, from 1 wt. % to 9 wt. %, from 1 wt. % to 8 wt. %, from 2 wt. % to 12 wt. %, from 2 wt. % to 10 wt. %, from 2 wt. % to 9 wt. %, from 2 wt. % to 8 wt. %, from 8 wt. % to 12 wt. %, from 8 wt. % to 10 wt. %, from 8 wt. % to 9 wt. %, from 9 wt. % to 12 wt. %, from 9 wt. % to 10 wt. %, or any and all sub-ranges formed from any of the endpoints of these ranges, of the B₂O₃ per unit weight of the composition.

The composition of the continuous basalt fibers may be expressed on a moles of oxide basis. In aspects, the composition of the continuous basalt fibers may comprise, on an oxide basis, greater than or equal to 0.5 mol % and less than or equal to 12 mol % of the B₂O₃. In aspects, the composition of the continuous basalt fibers may comprise, on an oxide basis, from 0.5 mol % to 12 mol %, from 0.5 mol % to 10 mol %, from 0.5 mol % to 9 mol %, from 0.5 mol % to 8 mol %, from 0.5 mol % to 2 mol %, from 1 mol % to 12 mol %, from 1 mol % to 10 mol %, from 1 mol % to 9 mol %, from 1 mol % to 8 mol %, from 2 mol % to 12 mol %, from 2 mol % to 10 mol %, from 2 mol % to 9 mol %, from 2 mol % to 8 mol %, from 8 mol % to 12 mol %, from 8 mol % to 10 mol %, from 8 mol % to 9 mol %, from 9 mol % to 12 mol %, from 9 mol % to 10 mol %, from 10 mol % to 12 mol %, or any and all sub-ranges formed from any of the endpoints of these ranges, of the B₂O₃ based on the total moles of oxides per unit volume of the composition.

In aspects, the composition of the continuous basalt fibers may include magnesium oxide (MgO). The MgO may be contributed mainly by the basalt raw material in the batch composition and/or may be added as an individual component. The presence of the MgO may reduce the viscosity of the melt used to produce the continuous basalt fibers, which may enhance the formability, strain point, and Young's modulus of the continuous basalt fibers. The composition of the continuous basalt fibers may include from 0 (zero) wt. % to 12 wt. % MgO based on the unit weight of the composition. In aspects, the composition of the continuous basalt fibers may comprise from 2 wt. % to 12 wt. %, from 2 wt. % to 11.5 wt. %, from 2 wt. % to 10 wt. %, from 2 wt. % to 8 wt. %, from 3 wt. % to 12 wt. %, from 3 wt. % to 11.5 wt. %, from 3 wt. % to 10 wt. %, from 3 wt. % to 8 wt. %, from 8 wt. % to 12 wt. %, from 8 wt. % to 11.5 wt. %, from 8 wt. % to 10 wt. %, from 10 wt. % to 12 wt. %, or any and all sub-ranges formed from any of the endpoints of these ranges, of the MgO per unit weight of the composition.

In aspects, the composition of the continuous basalt fibers may comprise, on an oxide basis, greater than or equal to 0 mol % and less than or equal to 12 mol % of the MgO. In aspects, the composition of the continuous basalt fibers may comprise, on an oxide basis, from 5 mol % to 20 mol %, from 5 mol % to 15 mol %, from 5 mol % to 12 mol %, from 6 mol % to 20 mol %, from 6 mol % to 15 mol %, from 6 mol % to 12 mol %, from 12 mol % to 20 mol %, from 12 mol % to 15 mol %, from 15 mol % to 20 mol %, or any and all sub-ranges formed from any of the endpoints of these ranges, of the MgO based on the total moles of oxides per unit volume of the composition.

In aspects, the composition of the continuous basalt fibers may include titanium dioxide (TiO₂) as a constituent, which may be contributed primarily by the basalt raw material and/or added as an individual component. In aspects, the composition of the continuous basalt fibers may comprise from 0 (zero) wt. % to 3 wt. % of the TiO₂ per unit weight of the composition. In aspects, the composition of the continuous basalt fibers disclosed herein may comprise from 0.1 wt. % to 3 wt. %, from 0.1 wt. % to 2.5 wt. %, from 0.1 wt. % to 2 wt. %, from 0.1 wt. % to 1 wt. %, from 0.1 wt. % to 0.5 wt. %, from 0.5 wt. % to 3 wt. %, from 0.5 wt. % to 2.5 wt. %, from 0.5 wt. % to 2 wt. %, from 0.5 wt. % to 1 wt. %, from 1 wt. % to 3 wt. %, from 1 wt. % to 2.5 wt. %, from 1 wt. % to 2 wt. %, from 2 wt. % to 3 wt. %, or any and all sub-ranges formed from any of the endpoints of these ranges, of the TiO₂ per unit weight of the composition.

In aspects, the composition of the continuous basalt fibers may comprise, on an oxide basis, greater than or equal to 0 mol % and less than or equal to 3 mol % of the TiO₂. In aspects, the composition of the continuous basalt fibers may comprise, on an oxide basis, from 0.1 mol % to 3 mol %, from 0.1 mol % to 2.5 mol %, from 0.1 mol % to 2 mol %, from 0.1 mol % to 0.5 mol %, from 0.5 mol % to 3 mol %, from 0.5 mol % to 2.5 mol %, from 0.5 mol % to 2 mol %, from 0.5 mol % to 1 mol %, from 1 mol % to 3 mol %, from 1 mol % to 2.5 mol %, from 1 mol % to 2 mol %, from 2 mol % to 3 mol %, or any and all sub-ranges formed from any of the endpoints of these ranges, of the TiO₂ based on the total moles of oxides per unit volume of the composition.

In aspects, the composition of the continuous basalt fibers may include manganese dioxide (MnO₂) as a constituent, which may be contributed primarily by the basalt raw material and/or added as an individual component. In aspects, the composition of the continuous basalt fibers may comprise from 0 (zero) wt. % to 1 wt. % of the MnO₂ per unit weight of the composition. In aspects, the composition of the continuous basalt fibers disclosed herein may comprise from 0.01 wt. % to 1 wt. %, from 0.01 wt. % to 0.6 wt. %, from 0.01 wt. % to 0.4 wt. %, from 0.01 wt. % to 0.2 wt. %, from 0.1 wt. % to 1 wt. %, from 0.1 wt. % to 0.6 wt. %, from 0.1 wt. % to 0.4 wt. %, from 0.1 wt. % to 0.2 wt. %, from 0.2 wt. % to 1 wt. %, from 0.2 wt. % to 0.6 wt. %, from 0.2 wt. % to 0.4 wt. %, from 0.4 wt. % to 1 wt. %, from 0.4 wt. % to 0.6 wt. %, from 0.6 wt. % to 1 wt. %, or any and all sub-ranges formed from any of the endpoints of these ranges, of the MnO₂ per unit weight of the composition.

In aspects, the composition of the continuous basalt fibers may comprise, on an oxide basis, greater than or equal to 0 (zero) mol % and less than or equal to 1 mol % of the MnO₂. In aspects, the composition of the continuous basalt fibers may comprise, on an oxide basis, from 0.01 mol % to 1 mol %, from 0.01 mol % to 0.6 mol %, from 0.01 mol % to 0.5 mol %, from 0.01 mol % to 0.3 mol %, from 0.01 wt. % to 0.2 wt. %, from 0.1 mol % to 1 mol %, from 0.1 mol % to 0.6 mol %, from 0.1 mol % to 0.5 mol %, from 0.1 mol % to 0.3 mol %, from 0.3 mol % to 1 mol %, from 0.3 mol % to 0.6 mol %, from 0.3 mol % to 0.5 mol %, from 0.5 mol % to 1 mol %, from 0.5 mol % to 0.06 mol %, from 0.6 mol % to 1 mol %, or any and all sub-ranges formed from any of the endpoints of these ranges, of the MnO₂ based on the total moles of oxides per unit volume of the composition.

Because the raw materials for the batch composition can include natural occurring rocks (i.e., basalt and colemanite), the composition of the continuous basalt fibers may comprise trace amounts of elements that are commonly present in naturally-occurring rocks that may not be present in pre-processed and purified batch materials. In aspects, the composition of the continuous basalt fibers may include phosphorous, uranium, thorium, or combinations of these. In aspects, the composition of the continuous basalt fibers may comprise from 0 (zero) wt. % to 0.2 wt. %, or about 0.1 wt. % phosphorous compounds (e.g., phosphorous pentoxide (P₂O₅) or other phosphorous oxides) per unit weight of the composition. In aspects, the composition of the continuous basalt fibers may comprise up to 5 parts per million by weight uranium, such as from 1 parts per billion by weight (ppbw) to about 5 ppmw uranium based on the unit weight of the composition. In aspects, the composition of the continuous basalt fibers may comprise up to 5 ppmw thorium, such as from 1 ppbw to 5 ppmw thorium per unit weight of the composition. These elements are in trace amounts, are naturally occurring in most rocks, and are not present in amounts that are toxic, unsafe, or environmentally destructive.

As previously discussed, the composition of the continuous basalt fibers may include iron oxides, which may act as fining agents. The iron oxide is naturally present in the basalt raw material. Thus, in some aspects, the composition of the continuous basalt fibers do not include any purposely added additional fining agents (other than the iron oxides) to facilitate production of the continuous basalt fibers. In aspects, the composition of the continuous basalt fibers do not contain any fining agents selected from the group consisting of SnO₂, As₂O₃, Sb₂O₃, CeO₂, F, Cl, and Br. In aspects, the composition of the continuous basalt fiber may comprise less than 0.01 mol % of fining agents based on the total moles of oxide in the continuous basalt fibers, where the fining agents are selected from the group consisting of SnO₂, As₂O₃, Sb₂O₃, CeO₂, F, Cl, and Br. In aspects, the composition of the continuous basalt fibers do not contain any purposely added sulfate fining agents. In aspects, the composition of the continuous basalt fibers may comprise less than 0.01 mol % of any purposely added sulfate fining agents, based on the total moles of oxides in the composition.

In aspects, the composition of the continuous basalt fibers may comprise, consist of, or consist essentially of from 35 wt. % to 60 wt. % SiO₂, from 7 wt. % to 20 wt. % Al₂O₃, from 7 wt. % to 24 wt. % iron oxides, from 8 wt. % to 20 wt. % CaO, from 1 wt. % to 5 wt. % alkali metal oxides, from 0.5 wt. % to 12 wt. % B₂O₃, optionally from 0.1 wt. % to 3 wt. % TiO₂, optionally from 2 wt. % to 20 wt. % MgO, optionally from 0.1 wt. % to 1 wt. % MnO₂, and optionally one or more constituents selected from the group consisting of phosphorous, uranium, thorium, and combinations thereof, wherein the weight percentages are per unit weight of the composition. In aspects, the composition of the continuous basalt fibers may comprise, consist of, or consist essentially of from 35.0 wt. % to 60.0 wt. % SiO₂, from 7.0 wt. % to 20.0 wt. % Al₂O₃, from 7.0 wt. % to 24.0 wt. % iron oxides, from 8.0 wt. % to 20.0 wt. % CaO, from 1.0 wt. % to 5.0 wt. % alkali metal oxides, from 0.50 wt. % to 12.0 wt. % B₂O₃, optionally from 0.10 wt. % to 3.0 wt. % TiO₂, optionally from 2.0 wt. % to 20.0 wt. % MgO, optionally from 0.10 wt. % to 1.0 wt. % MnO₂, and optionally one or more constituents selected from the group consisting of phosphorous, uranium, thorium, and combinations thereof, wherein the weight percentages are per unit weight of the composition.

In aspects, the composition of the continuous basalt fibers may comprise, consist of, or consist essentially of from 36 wt. % to 52 wt. % SiO₂; from 11.5 wt. % to 18.5 wt. % Al₂O₃; from 7.5 wt. % to 20 wt. % iron oxides; from 3 wt. % to 8 wt. % MgO; from 0.5 wt. % to 2 wt. % TiO₂; from 10 wt. % to 15 wt. % CaO; from 1.8 wt. % to 4.2 wt. % alkali metal oxides; from 2 wt. % to 9 wt. % B₂O₃; optionally from 0.1 wt. % to 1 wt. % MnO₂, wherein the weight percentages are based on the unit weight of the composition; and optionally one or more constituents selected from the group consisting of phosphorous, uranium, thorium, and combinations thereof. In aspects, the composition of the continuous basalt fibers may comprise, consist of, or consist essentially of from 36.0 wt. % to 52.0 wt. % SiO₂; from 11.5 wt. % to 18.5 wt. % Al₂O₃; from 7.5 wt. % to 20.0 wt. % iron oxides; from 3.0 wt. % to 8.0 wt. % MgO; from 0.50 wt. % to 2.0 wt. % TiO₂; from 10.0 wt. % to 15.0 wt. % CaO; from 1.8 wt. % to 4.2 wt. % alkali metal oxides; from 2.0 wt. % to 9.0 wt. % B₂O₃, wherein the weight percentages are based on the unit weight of the composition; optionally from 0.10 wt. % to 1.0 wt. % MnO₂; and optionally one or more constituents selected from the group consisting of phosphorous, uranium, thorium, and combinations thereof.

The compositions and/or continuous basalt fibers disclosed herein may have a Young's modulus of greater than or equal to 80 GPa, such as greater than or equal to 85 GPa, or even greater than or equal to 90 GPa. In aspects, the compositions and/or continuous basalt fibers may have a Young's modulus of from 80 GPa to 120 GPa, from 80 GPa to 110 GPa, from 85 GPa to 120 GPa, from 85 GPa to 110 GPa, from 85 GPa to 105 GPa, from 90 GPa to 120 GPa, from 90 GPa to 110 GPa, from 90 GPa to 105 GPa, or any and all sub-ranges formed from any of the endpoints of these ranges. In aspects, the compositions and/or continuous basalt fibers disclosed herein may have a Young's modulus that is greater than a Young's modulus that is 10 GPa less than the Young's modulus of a comparative basalt fiber. As used herein, the “comparative basalt fiber” discussed herein, unless otherwise stated, refers to a basalt fiber made with basalt only with no added colemanite or other constituents, wherein the basalt used to make the continuous basalt fiber according to the present disclosure and the basalt used to make the comparative basalt fiber are from the same source and have the same general composition (i.e., basalts obtained from the same source and having a composition that is within 0.5 wt. % for each constituent). In aspects, the compositions and/or continuous basalt fibers disclosed herein may have a Young's modulus such that a difference between the Young's modulus of the composition and/or continuous basalt fiber and a Young's modulus of the comparative basalt fiber is less than 10 GPa, less than or equal to 6 GPa, or even less than or equal to 5 GPa. The Young's moduli and tensile strengths of the continuous basalt fiber and/or the comparative basalt fiber are determined according to the standard test method in ASTM C1557-20.

In aspects, the continuous basalt fibers disclosed herein may have an aged fiber tensile strength of greater than or equal to 1000 MPa, such as greater than or equal to 1050 MPa, or even greater than or equal to 1075 MPa. In aspects, the continuous basalt fibers may have an aged fiber tensile strength of from 1000 MPa to 1200 MPa, such as from 1050 MPa to 1175 MPa, or any and all sub-ranges formed from any of the endpoints of these ranges. The aged fiber tensile strength of the continuous basalt fibers refers to the fiber tensile strength measured 1 day after the continuous basalt fiber is drawn (i.e., the fiber is aged for 1 day after being formed by the drawing process). The tensile strength of the aged fibers is measured according to methods known in the art. In aspects, the compositions and/or the continuous basalt fibers disclosed herein may have a Poisson's ratio of from 0.248 to 0.271. The Poisson's ratio may be calculated from measured stress and strain values according to known methods.

In aspects, the compositions and/or the continuous basalt fibers may have a density of from 2.7 grams per centimeter cubed (g/cm³) to 3.2 g/cm³, such as from 2.7 g/cm³ to 3.1 g/cm³, from 2.7 g/cm³ to 3.05 g/cm³, from 2.72 g/cm³ to 3.2 g/cm³, from 2.72 g/cm³ to 3.1 g/cm³, from 2.72 g/cm³ to 3.05 g/cm³, from 2.9 g/cm³ to 3.2 g/cm³, from 2.9 g/cm³ to 3.1 g/cm³, from 2.9 g/cm³ to 3.05 g/cm³, or any and all sub-ranges formed from any of the endpoints of these ranges. The density of the compositions and/or continuous basalt fibers disclosed herein are determined using a gas pycnometer according to the standard test method in ASTM D2320. In aspects, the compositions and/or continuous basalt fibers may have a density that is less than the density of the comparative basalt fiber (i.e., previously defined as a basalt fiber made with basalt only with no added colemanite or other constituents, wherein the basalt used to make the continuous basalt fiber according to the present disclosure and the basalt used to make the comparative basalt fiber have the same general composition).

As previously discussed, adding the colemanite, or other boron and/or calcium sources, to the basalt in the batch composition reduces the melt temperature of the batch composition and the continuous basalt fibers made therefrom compared to the basalt by itself. The melt temperature of the composition, the continuous basalt fibers, and/or the batch composition may be determined through differential scanning calorimetry (DSC) through known methods. In aspects, the compositions and/or continuous basalt fibers may have a melt temperature that is at least 20° C. less than the melt temperature of the comparative basalt fibers, such as at least 30° C. less, at least 50° C. less, or even at least 100° C. less than the melt temperature of the comparable basalt fibers. In aspects, the compositions and/or continuous basalt fibers may have a melt temperature that is from 20° C. to 300° C., from 20° C. to 250° C., from 25° C. to 300° C., from 25° C. to 250° C., or any and all sub-ranges formed from any of the endpoints of these ranges, less than the melt temperature of the comparative basalt fibers (previously defined, same basalt composition but no colemanite or other added boron source). In aspects, the compositions and/or continuous basalt fibers may have a melt temperature of less than 1500° C., less than or equal to 1450° C., less than or equal to 1425° C., less than or equal to 1400° C., or less than or equal to 1350° C., as determined through DSC. In aspects, the compositions and/or continuous basalt fibers may have a melt temperature of from 1200° C. to 1490° C., from 1200° C. to 1475° C., from 1200° C. to 1450° C., from 1200° C. to 1430° C., from 1200° C. to 1425° C., from 1200° C. to 1400° C., from 1200° C. to 1375° C., from 1200° C. to 1350° C., from 1220° C. to 1450° C., from 1220° C. to 1430° C., from 1220° C. to 1425° C., from 1220° C. to 1400° C., from 1220° C. to 1375° C., or any and all sub-ranges formed from any of the endpoints of these ranges.

Including the colemanite in the batch composition for making the continuous basalt fibers may also reduce the glass transition temperature (T_{g}) of the compositions and the continuous basalt fibers made therefrom compared to the comparative basalt fibers (previously defined herein) made from the basalt by itself. The glass transition temperatures of the compositions, the continuous basalt fibers, or the batch compositions may be determined through differential scanning calorimetry (DSC) through known methods, such as the standard test method in ASTM E1356. In aspects, the compositions and/or continuous basalt fibers may have a glass transition temperature that is at least 20° C. less or even at least 30° C. less than the glass transition temperature of the comparative basalt fibers (previously defined, same basalt composition but not colemanite). In aspects, the compositions and/or continuous basalt fibers may have a glass transition temperature that is from 20° C. to 100° C., from 20° C. to 75° C., from 20° C. to 50° C., from 25° C. to 100° C., from 25° C. to 75° C., from 25° C. to 50° C., from 30° C. to 100° C., from 30° C. to 75° C., from 30° C. to 50° C., or any and all sub-ranges formed from any of the endpoints of these ranges, less than the glass transition temperature of the comparative basalt fibers. In aspects, the compositions and/or continuous basalt fibers may have a glass transition temperature of less than or equal to 700° C., or less than or equal to 690° C., as determined through DSC. In aspects, the compositions and/or continuous basalt fibers may have a melt temperature of from 600° C. to 700° C., such as from 600° C. to 690° C., from 600° C. to 675° C., from 600° C. to 665° C., from 610° C. to 700° C., from 610° C. to 690° C., from 610° C. to 675° C., from 610° C. to 665° C., from 625° C. to 700° C., from 625° C. to 690° C., from 625° C. to 675° C., from 625° C. to 665° C., or any and all sub-ranges formed from any of the endpoints of these ranges.

In aspects, the compositions and/or continuous basalt fibers disclosed herein may have a crystallization temperature (Tₓ) of from 750° C. to 925° C., such as from 750° C. to 910° C., from 750° C. to 900° C., from 750° C. to 885° C., from 775° C. to 925° C., from 775° C. to 910° C., from 775° C. to 900° C., from 775° C. to 885° C., from 795° C. to 925° C., from 795° C. to 910° C., from 795° C. to 900° C., from 795° C. to 885° C., or any and all sub-ranges formed from any of the endpoints of these ranges. As used herein, the term “crystallization temperature” refers to the temperature at the onset of crystallization. In aspects, the compositions and/or continuous basalt fibers may have a crystallization temperature that is different from a crystallization temperature of the comparative basalt fiber (previously defined herein). The crystallization temperature of the continuous basalt fibers may be determined from DSC through known methods.

The compositions and continuous basalt fibers disclosed herein, which are made from basalt, colemanite, and optionally other components, may be characterized by a difference between the crystallization temperature and the glass transition temperature (i.e., (Tₓ-T_{g})). The compositions and/or continuous basalt fibers disclosed herein may have a (Tₓ-T_{g}) that is greater than the (Tₓ-T_{g}) of the comparative basalt fibers. This increased (Tₓ-T_{g}) for the composition and/or continuous basalt fibers disclosed herein provides an indication of the greater stability of the glass-like network of the composition and/or continuous basalt fibers compared to the comparative fibers. In other words, the continuous basalt fibers can be drawn from the melt over a larger temperature range without resulting in crystallization of the constituents of the continuous basalt fibers. In aspects, the compositions and/or continuous basalt fibers may have a (Tₓ-T_{g}) that is at least 10° C. greater than the (Tₓ-T_{g}) of the comparative basalt fibers, such as at least 14° C. greater or at least 17° C. greater than the (Tₓ-T_{g}) of the comparative basalt fibers. In aspects, the compositions and/or the continuous basalt fibers may have a (Tₓ-T_{g}) that is from 10° C. to 50° C. greater than the (Tₓ-T_{g}) of the comparative basalt fibers, such as from 10° C. to 40° C., from 10° C. to 30° C., from 14° C. to 50° C., from 14° C. to 40° C., from 14° C. to 30° C., from 17° C. to 50° C., from 17° C. to 40° C., from 17° C. to 30° C., from 20° C. to 50° C., from 20° C. to 40° C., from 20° C. to 30° C., or any and all sub-ranges formed from any of the endpoints of these ranges, greater than the (Tₓ-T_{g}) of the comparative basalt fibers. In aspects, the compositions and/or the continuous basalt fibers disclosed herein may have a (Tₓ-T_{g}) of from 100° C. to 220° C., such as from 100° C. to 210° C., from 150° C. to 220° C., from 150° C. to 210° C., from 165° C. to 220° C., from 165° C. to 210° C., from 170° C. to 220° C., from 170° C. to 210° C., from 175° C. to 220° C., from 175° C. to 210° C., from 180° C. to 220° C., from 180° C. to 210° C., from 190° C. to 220° C., from 200° C. to 220° C., or any and all sub-ranges formed from any of the endpoints of these ranges.

The inclusion of the colemanite in the compositions of the continuous basalt fibers may reduce the liquidus temperature of the continuous basalt fibers compared to the comparative basalt fibers (previously defined herein). In aspects, the compositions and/or the continuous basalt fibers may have a liquidus temperature less than the liquidus temperature of the comparative basalt fiber. In aspects, the compositions and/or the continuous basalt fibers may have a liquidus temperature that is at least 20° C., or even at least 25° C. less than the liquidus temperature of the comparative basalt fiber. In aspects, the compositions and/or the continuous basalt fibers disclosed herein may have a liquidus temperature of from 1100° C. to 1310° C., such as from 1100° C. to 1300° C., from 1100° C. to 1295° C., from 1110° C. to 1310° C., from 1110° C. to 1300° C., from 1110° C. to 1295° C., from 1150° C. to 1310° C., from 1150° C. to 1300° C., from 1150 to 1295° C., from 1115° C. to 1295° C., or any and all sub-ranges formed from any of the endpoints of these ranges. The liquidus temperature of the compositions and/or continuous basalt fibers may be determined by DSC according to known methods.

In aspects, the compositions and/or the continuous basalt fibers disclosed herein may have a strain point temperature of from 560° C. to 700° C., such as from 560° C. to 680° C., from 560° C. to 675° C., from 565° C. to 700° C., from 565° C. to 680° C., from 565° C. to 675° C., from 575° C. to 700° C., from 575° C. to 680° C., from 600° C. to 700° C., or any and all sub-ranges formed from any of the endpoints of these ranges. In aspects, the compositions and/or the continuous basalt fibers disclosed herein may have an anneal point temperature of from 600° C. to 725° C., such as from 600° C. to 700° C., from 600° C. to 675° C., from 615° C. to 725° C., from 615° C. to 700° C., from 615° C. to 675° C., from 630° C. to 725° C., from 630° C. to 700° C., from 630° C. to 675° C., or any and all sub-ranges formed from any of the endpoints of these ranges. The strain point temperature and the anneal point temperature of the compositions and/or continuous basalt fibers may be determined using a beam bending viscometer according to the standard test method in ASTM C598-23. The compositions and/or continuous basalt fibers may have an anneal point temperature that is less than the strain point temperature by from 34° C. to 41° C.

The continuous basalt fibers disclosed herein may be produced according to a method that may comprise preparing a batch composition from basalt, colemanite, and/or other individual components, heating the batch composition to a forming temperature to produce a melt, drawing a continuous strand from the melt, and cooling the continuous strand to produce the continuous basalt fiber. Preparing the batch composition may comprising combining from 75 wt. % to 99.5 wt. % basalt with from 0.5 wt. % to 25 wt. % colemanite to produce the batch composition. The basalt and colemanite may be provided as size-reduced solids, such as powders, and combining the basalt and colemanite may be accomplished with any type of equipment suitable for compounding the solid components to produce a generally homogeneous mixture.

In aspects, the batch compositions for making the continuous basalt fibers may comprise from 75 wt. % to 98 wt. %, from 75 wt. % to 95 wt. %, from 75 wt. % to 92.5 wt. %, from 75 wt. % to 90 wt. %, from 75 wt. % to 88 wt. %, from 75 wt. % to 85 wt. %, from 80 wt. % to 99.5 wt. %, from 80 wt. % to 98 wt. %, from 80 wt. % to 95 wt. %, from 80 wt. % to 92.5 wt. %, from 80 wt. % to 90 wt. %, from 80 wt. % to 88 wt. %, from 80 wt. % to 85 wt. %, from 85 wt. % to 99.5 wt. %, from 85 wt. % to 98 wt. %, from 85 wt. % to 95 wt. %, from 85 wt. % to 92.5 wt. %, from 85 wt. % to 90 wt. %, from 85 wt. % to 88 wt. %, from 88 wt. % to 99.5 wt. %, from 88 wt. % to 98 wt. %, from 88 wt. % to 95 wt. %, from 88 wt. % to 92.5 wt. %, from 88 wt. % to 90 wt. %, from 90 wt. % to 99.5 wt. %, from 90 wt. % to 98 wt. %, from 90 wt. % to 95 wt. %, from 90 wt. % to 92.5 wt. %, from 92.5 wt. % to 99.5 wt. %, from 92.5 wt. % to 98 wt. %, from 92.5 wt. % to 95 wt. %, from 95 wt. % to 99.5 wt. %, from 95 wt. % to 98 wt. %, from 98 wt. % to 99.5 wt. %, or any and all sub-ranges formed from any of the endpoints of these ranges, of the basalt based on the total weight of the batch composition.

The batch compositions may include any suitable amount of colemanite. For example, in aspects, an amount of the colemanite can be provided that is sufficient to reduce the melt temperature, but less than an amount that significantly reduces the mechanical properties of the continuous basalt fibers made therefrom. In aspects, the batch compositions for making the continuous basalt fibers may comprise from 0.5 wt. % to 25 wt. %, from 0.5 wt. % to 20 wt. %, from 0.5 wt. % to 15 wt. %, from 0.5 wt. % to 10 wt. %, from 0.5 wt. % to 7.5 wt. %, from 1 wt. % to 25 wt. %, from 1 wt. % to 20 wt. %, from 1 wt. % to 15 wt. %, from 1 wt. % to 10 wt. %, from 1 wt. % to 7.5 wt. %, from 2 wt. % to 25 wt. %, from 2 wt. % to 20 wt. %, from 2 wt. % to 15 wt. %, from 2 wt. % to 10 wt. %, from 2 wt. % to 7.5 wt. %, from 5 wt. % to 25 wt. %, from 5 wt. % to 20 wt. %, from 5 wt. % to 15 wt. %, from 5 wt. % to 10 wt. %, from 5 wt. % to 7.5 wt. %, from 7.5 wt. % to 25 wt. %, from 7.5 wt. % to 20 wt. %, from 7.5 wt. % to 15 wt. %, from 7.5 wt. % to 10 wt. %, from 10 wt. % to 25 wt. %, from 10 wt. % to 20 wt. %, from 10 wt. % to 15 wt. %, from 15 wt. % to 25 wt. %, from 15 wt. % to 20 wt. %, or any and all sub-ranges formed from any of the endpoints of these ranges, of the colemanite based on the total weight of the batch composition.

In aspects, the batch composition may comprise one or a plurality of individual components in place of or in additional to either the colemanite, the basalt, or both. Individual components may include SiO₂, SiO₂ precursors, Al₂O₃, Al₂O₃ precursors, iron oxides, iron oxide precursors, CaO, CaO precursors, alkali metal oxides, alkali metal oxide precursors, B₂O₃, B₂O₃ precursors, MgO, MgO precursors, TiO₂, TiO₂ precursors, MnO₂, MnO₂ precursors, other constituents, or combinations thereof.

The batch composition comprising the combination of the basalt and the colemanite may include, on an oxides basis, SiO₂, Al₂O₃, iron oxides (e.g., FeO, Fe₂O₃, etc.), CaO, alkali metal oxides (e.g., Na₂O, K₂O, etc.), and B₂O₃. In aspects, the batch composition may also include, on an oxides basis, MgO, TiO₂, and MnO₂. Being produced from naturally-occurring rocks, the batch composition may also include trace elements, such as phosphorous, uranium, thorium, and other elements found in naturally-occurring rocks but not typically present in pre-processed and relatively pure batch materials. Although some constituents of the batch composition may volatilize (e.g., evaporate) from the surface during melting and drawing of the continuous basalt fiber from the melt, the loss of these compounds is minimal, such that the composition of the continuous basalt fiber generally has the same composition, on an oxide basis, as the batch composition. The batch compositions may also include precursors of the oxides discussed herein, and these precursors may be converted to the corresponding oxides in the composition during the melting and forming of the continuous basalt fibers. Thus, the batch composition can be considered to have any of the constituents and concentrations of constituents, on an oxide basis, previously discussed herein for the compositions and/or the continuous basalt fibers made therefrom.

In aspects, the batch composition may comprise, on an oxides basis, from 35 wt. % to 60 wt. % SiO₂ and/or SiO₂ precursors, from 7 wt. % to 20 wt. % Al₂O₃ and/or Al₂O₃ precursors, from 7 wt. % to 24 wt. % iron oxides and/or iron oxide precursors, from 8 wt. % to 20 wt. % CaO and/or CaO precursors, from 1 wt. % to 5 wt. % alkali metal oxides and/or alkali metal oxide precursors, and from 0.5 wt. % to 12 wt. % B₂O₃ and/or B₂O₃ precursors, wherein the weight percentages are based on a unit weight of the batch composition. In aspects, the batch compositions may further include, on an oxides basis, from 2 to 20 wt. % MgO and/or MgO precursors, from 0.1 wt. % to 3 wt. % TiO₂ and/or TiO₂ precursors, from 0.1 wt. % to 1 wt. % MnO₂ and/or MnO₂ precursors, or any combinations thereof, wherein the weight percentages are based on the total weight of the batch composition.

In aspects, the batch composition may consist of or consist essentially of, on an oxides basis, from 35 wt. % to 60 wt. % SiO₂ and/or SiO₂ precursors, from 7 wt. % to 20 wt. % Al₂O₃ and/or Al₂O₃ precursors, from 7 wt. % to 24 wt. % iron oxides and/or iron oxide precursors, from 8 wt. % to 20 wt. % CaO and/or CaO precursors, from 1 wt. % to 5 wt. % alkali metal oxides and/or alkali metal oxide precursors, from 0.5 wt. % to 12 wt. % B₂O₃ and/or B₂O₃ precursors, optionally from 0.1 wt. % to 3 wt. % TiO₂ and/or TiO₂ precursors, optionally from 2 wt. % to 20 wt. % MgO and/or MgO precursors, optionally from 0.1 wt. % to 1 wt. % MnO₂ and/or MnO₂ precursors, wherein the weight percentages are based on the unit weight of the batch composition, and optionally one or more constituents selected from the group consisting of phosphorous, uranium, thorium, and combinations thereof. In aspects, the batch composition may comprise, consist of, or consist essentially of, on an oxides basis, from 36 wt. % to 52 wt. % SiO₂ and/or SiO₂ precursors; from 11.5 wt. % to 18.5 wt. % Al₂O₃ or Al₂O₃ precursors; from 7.5 wt. % to 20 wt. % iron oxides and/or iron oxide precursors; from 3 wt. % to 8 wt. % MgO and/or MgO precursors; from 0.5 wt. % to 2 wt. % TiO₂ and/or TiO₂ precursors; from 10 wt. % to 15 wt. % CaO and/or CaO precursors; from 1.8 wt. % to 4.2 wt. % alkali metal oxides and/or alkali metal oxide precursors; from 2 wt. % to 9 wt. % B₂O₃ and/or B₂O₃ precursors; optionally from 0.1 wt. % to 1 wt. % MnO₂ and/or MnO₂ precursors; wherein the weight percentages are based on the unit weight of the batch composition (i.e., weight of the material when converted to the oxide divided by the total weight of the batch composition); and optionally one or more constituents selected from the group consisting of phosphorous, uranium, thorium, and combinations thereof.

In aspects, the batch composition may consist of or consist essentially of the basalt and the colemanite. In aspects, the basalt raw material may have a low concentration of alkali metal oxides. As previously discussed, if the concentration of the alkali metal oxides is too low, the meltability of the batch composition may be impacted. Thus, in aspects, preparing the batch composition may further include adding supplemental alkali metal oxides or metal oxide precursors, such as but not limited to Na₂O, K₂O, other alkali metal containing compounds, or combinations thereof, to the batch composition to increase the concentration of the alkali metal oxides, on an oxides basis, into the range of from 1 wt. % to 5 wt. %. Other precursors may be included I the batch composition to produce the oxides (e.g., SiO₂, Al₂O₃, iron oxides, MgO, TiO₂, CaO, B₂O₃, MnO₂, etc.).

In aspects, preparing the batch composition may comprise combining the basalt and colemanite and then melting the basalt and colemanite mixture to form blocks with a homogeneous composition. The blocks may be subsequently cooled. The blocks may then be subsequently re-melted to form the melt during production of the continuous basalt fibers. In this regard, the process conditions disclosed elsewhere herein for preparing the batch composition into fibers are equally applicable to preparing the blocks into fibers.

The blocks may be tested to determine mechanical properties of the blocks prior to formation of the continuous basalt fibers. In aspects, the blocks may have a shear modulus of greater than or equal to 35 GPa, such as from 35 GPa to 50 GPa, from 35 GPa to 45 GPa, from 35 GPa to 42 GPa, or any and all sub-ranges formed from any of the endpoints of these ranges. In aspects, the blocks comprising the batch composition may have a Young's modulus of from 80 GPa to 120 GPa, such as from 80 GPa to 110 GPa, from 80 GPa to 105 GPa, from 80 GPa to 90 GPa, from 85 GPa to 120 GPa, from 85 GPa to 110 GPa, from 85 GPa to 105 GPa, from 85 GPa to 90 GPa, from 90 GPa to 120 GPa, from 90 GPa to 110 GPa, from 90 GPa to 105 GPa, from 105 GPa, to 120 GPa, or any and all sub-ranges formed from any of the endpoints of these ranges. In aspects, the blocks may have a bulk modulus of greater than or equal to 59 GPa, such as greater than or equal to 60 GPa, from 59 GPa to 90 GPa, from 59 GPa to 80 GPa, from 60 GPa to 90 GPa, from 60 GPa to 80 GPa, or any and all sub-ranges formed from any of the endpoints of these ranges. In aspects, the blocks comprising the batch composition may have a density of from 2.7 g/cm³ to 3.3 g/cm³, such as from 2.7 g/cm³ to 3.2 g/cm³, from 2.7 g/cm³ to 3.1 g/cm³, from 2.72 g/cm³ to 3.3 g/cm³, from 2.72 g/cm³ to 3.2 g/cm³, from 2.72 g/cm³ to 3.1 g/cm³, from 2.9 g/cm³ to 3.3 g/cm³, from 2.9 g/cm³ to 3.2 g/cm³, from 2.9 g/cm³ to 3.1 g/cm³, or any and all sub-ranges formed from any of the endpoints of these ranges.

Following preparation of the batch composition, the batch composition (e.g., in the form of a powder mixture) and/or block may be heated to the forming temperature to produce the melt. The batch composition and/or block may be heated in a crucible contained within a furnace. In aspects, the batch composition and/or block may be heated by using electric heating elements. In aspects, the batch composition and/or block may be heated by submerging electrodes within the batch composition to more uniformly heat the batch composition.

The forming temperature may be greater than or equal to the melt temperature of the batch composition and/or block. In aspects, the batch composition and/or block may be heated to the forming temperature of less than 1500° C., such as less than or equal to 1490° C., less than or equal to 1475° C., less than or equal to 1450° C., of less than or equal to 1400° C. In aspects, the batch composition may be heated to a forming temperature of from 1200° C. to 1500° C., from 1200° C. to 1490° C., from 1200° C. to 1475° C., from 1200° C. to 1450° C., from 1200° C. to 1430° C., from 1200° C. to 1425° C., from 1200° C. to 1400° C., from 1200° C. to 1375° C., from 1200° C. to 1350° C., from 1220° C. to 1500° C., from 1220° C. to 1490° C., from 1220° C. to 1475° C., from 1220° C. to 1450° C., from 1220° C. to 1430° C., from 1220° C. to 1425° C., from 1220° C. to 1400° C., from 1220° C. to 1375° C., or any and all sub-ranges formed from any of the endpoints of these ranges.

The crucible for heating the batch composition and/or block may have a hole or other orifice in the bottom of it, and a continuous molten basalt fiber may be drawn from the melt in the crucible through the hole/orifice in the bottom of the crucible. The fiber drawn from the melt may be rapidly cooled to produce the continuous basalt fibers disclosed herein. Drawing a continuous basalt fiber from a molten batch composition and/or block and cooling the continuous basalt fiber may be accomplished by any known technique or process. The resulting continuous basalt fibers may have any of the compositions or properties previously described herein for the continuous basalt fibers.

The compositions and/or continuous basalt fibers disclosed herein may be useful in a variety of articles, such as composite articles including the continuous basalt fibers distributed throughout a volume of another material, such as a polymer, cement, resin, metal, or other material. Examples of articles that may be made from composite materials containing the basalt fibers herein may include but are not limited to hard disk substrates, wind turbine blades, pressurized tanks, building materials, substitute materials for asbestos, insulation, passive fire protection materials, aircraft structures, spacecraft structures, electronics packaging, sporting goods, or other composite articles.

### Examples

The various aspects of the compositions and methods disclosed herein will be further clarified by the following examples. The examples are illustrative in nature, and should not be understood to limit the subject matter of the present disclosure.

For Comparative Examples A, B, and C, batch compositions comprising only basalt were prepared and then formed into homogeneous blocks. Comparative A was prepared from Columbia River basalt, Comparative Example B was prepared with Archean basalt, and Comparative Example C was prepared with a Hawaii 4 basalt. The measured compositions of the Columbia River, Archean, and Hawaii 4 basalts are provided in Table 1 and are the same as the measured compositions of the homogeneous blocks prepared for Comparative Examples A-C. The homogeneous blocks were prepared by heating a mass of basalt powder above the melt temperature of the basalt to form a molten glass, and then pouring the melt on a table, which cools the molten glass back to room temperature to form a homogeneous glass block having a composition near the desired batch composition, on an oxide basis.

Comparative Example E is E-Glass made from processed raw materials. Comparative Example F is an S-Glass made from processed raw materials. Comparative Example G is an R-Glass made from processed raw materials. The compositions for Comparative Examples E, F, and G are provided in Table 1.

For Examples 1-7, batch compositions comprising basalt and colemanite, according to the present disclosure, were prepared and formed into homogeneous blocks. The batch compositions of Examples 1-3 were made with the Columbia River basalt having the composition of Comparative Example A (on an oxide basis), the batch composition of Example 4 was made with the Archean basalt of Comparative Example B, the batch composition of Examples 5 and 6 were made from the Hawaii 4 basalt of Comparative Example C, and the batch composition of Example 7 was prepared using a Hawaii 5 basalt, which was a basalt obtained from a different location in the Hawaiian Islands. The colemanite was mined in California. For Examples 1-7, the homogeneous blocks were prepared by mixing powders of the basalt, colemanite, or other raw materials to form the batch composition in the form of a homogeneous powder mixture, heating the powder mixture above the melting point temperature of the batch composition to form molten glass, and then pouring the melt on a table, which cools the molten glass back to room temperature to form a homogeneous glass block having a composition near the desired batch composition, on an oxide basis. The measured compositions of blocks and weight percentage of the colemanite included in the batch compositions are provided in Table 1.

The homogeneous blocks of Comparative Examples A-D and Examples 1-7 were then evaluated for composition and physical properties, including glass transition temperature (T_{g}), crystallization temperature (Tₓ, e.g., the temperature at the onset of crystallization), peak crystallization temperature (T_{x, peak}), difference between crystallization temperature and glass transition temperature (Tₓ-T_{g}), melt temperature (Tₘ), liquidus temperature (TL), strain point temperature (Tₛ), anneal point temperature (T_{A}), difference between anneal point temperature and strain point temperature (T_{A}-T_{S}), shear modulus, Young's modulus, bulk modulus, Poisson's ratio, density, and SP mod according to the test methods disclosed herein. The compositions and results are provided in Table 1.

TABLE 1

| | A | 1 | 2 | 3 |
|---|---|---|---|---|
| Type of Composition | Basalt Only | Basalt + | Basalt + | Basalt + |
| | | Colemanite | Colemanite | Colemanite |
| Basalt Source | Columbia | Columbia | Columbia | Columbia |
| | River | River | River | River |
| Colemanite (wt. %) | — | 5.0 | 10.0 | 20.0 |

Composition in Weight Percentage (wt. %)

| | | | | |
|---|---|---|---|---|
| SiO₂ (wt. %) | 53.6 | 51.2 | 49.6 | 46.2 |
| Al₂O₃ (wt. %) | 13.9 | 13.2 | 12.6 | 11.7 |
| Iron Oxides (wt. %) | 8.91 | 8.5 | 8.5 | 7.8 |
| K₂O (wt. %) | 2.12 | 1.9 | 1.9 | 1.7 |
| Na₂O (wt. %) | 2.32 | 2.2 | 2.1 | 1.9 |
| MgO (wt. %) | 7.04 | 6.9 | 6.9 | 6.4 |
| TiO₂ (wt. %) | 0.88 | 0.8 | 0.8 | 0.7 |
| MnO₂ (wt. %) | 0.28 | 0.3 | 0.3 | 0.2 |
| CaO (wt. %) | 10.1 | 11.4 | 12.2 | 14.2 |
| B₂O₃ (wt. %) | — | 2.7 | 4.3 | 8.3 |
| Total (wt. %) | 99.15 | 99.1 | 99.2 | 99.1 |
| Total Alkali Metal Oxides | 4.44 | 4.1 | 4.0 | 3.6 |

Composition in Mole Percentage (mol % on an oxide basis)

| | | | | |
|---|---|---|---|---|
| SiO₂ (mol %) | 58.9 | 56.1 | 54.3 | 50.4 |
| Al₂O₃ (mol %) | 9.0 | 8.5 | 8.1 | 7.5 |
| Iron Oxides (mol %) | 3.7 | 3.5 | 3.5 | 3.2 |
| K₂O (mol %) | 1.5 | 1.4 | 1.3 | 1.2 |
| Na₂O (mol %) | 2.5 | 2.3 | 2.2 | 2.0 |
| MgO (mol %) | 11.6 | 11.4 | 11.3 | 10.5 |
| TiO₂ (mol %) | 0.7 | 0.7 | 0.7 | 0.6 |
| MnO₂ (mol %) | 0.2 | 0.2 | 0.2 | 0.2 |
| CaO (mol %) | 11.9 | 13.4 | 14.3 | 16.6 |
| B₂O₃ (mol %) | — | 2.5 | 4.1 | 7.8 |
| Total (mol %) | 100.0 | 100.0 | 100.0 | 100.0 |
| Total Alkali Metal Oxides | 4.0 | 3.7 | 3.5 | 3.2 |

Properties

| | | | | |
|---|---|---|---|---|
| T_{g} (° C.) | 662 | 631.3 | 625.2 | 609.7 |
| Tₓ (° C.) | 830.7 | 814.3 | 814.7 | 820 |
| T_{x, peak} (° C.) | 905.3 | 873.6 | 843 | 864.6 |
| (Tₓ − T_{g}) (° C.) | 169 | 183 | 190 | 210 |
| Tₘ (° C.) | 1450 | 1422.5 | 1373.1 | 1224.8 |
| T_{L} (° C.) | 1320 | 1295 | 1250 | 1115 |
| T_{S} (° C.) | 613.4 | 596.1 | 581.3 | 581.3 |
| T_{A} (° C.) | 652.9 | 635.4 | 618.1 | 618.3 |
| (T_{A} − T_{S}) (° C.) | 39.5 | 39.3 | 36.8 | 37.0 |
| Shear modulus (GPa) | 36.1 | 36.0 | 35.8 | 35.4 |
| Young's modulus (GPa) | 90.3 | 89.8 | 89.4 | 88.9 |
| Bulk modulus (GPa) | 59.9 | 59.4 | 59.3 | 60.3 |
| Poisson's ratio | 0.249 | 0.248 | 0.249 | 0.254 |
| Density (g/cm³) | 2.730 | 2.729 | 2.729 | 2.726 |
| SP mod | 33.1 | 32.9 | 32.7 | 32.6 |

| | B | 4 | C | 5 | 6 |
|---|---|---|---|---|---|
| Type of Composition | Basalt | Basalt + | Basalt | Basalt + | Basalt + |
| | | Colemanite | | Colemanite | Colemanite |
| Basalt Source | Archean | Archean | Hawaii 4 | Hawaii 4 | Hawaii 4 |
| Colemanite (wt. %) | — | 7.5 | — | 7.5 | 15.0 |

Composition in Weight Percentage (wt. %)

| | | | | | |
|---|---|---|---|---|---|
| SiO₂ (wt. %) | 40.63 | 37.88 | 41.68 | 38.8 | 36.17 |
| Al₂O₃ (wt. %) | 19.62 | 18.35 | 18.378 | 17.343 | 16.192 |
| Iron Oxides (wt. %) | 20.41 | 19.11 | 22.772 | 21.325 | 19.802 |
| K₂O (wt. %) | 0.211 | 0.18 | 0.496 | 0.43 | 0.335 |
| Na₂O (wt. %) | 2.063 | 1.87 | 1.835 | 1.689 | 1.505 |
| MgO (wt. %) | 3.454 | 3.20 | 4.06 | 3.724 | 3.421 |
| TiO₂ (wt. %) | 0.764 | 0.71 | 2.127 | 1.992 | 1.858 |
| MnO₂ (wt. %) | 0.568 | 0.54 | 0.569 | 0.539 | 0.503 |
| CaO (wt. %) | 12.059 | 14.01 | 8.027 | 10.199 | 12.501 |
| B₂O₃ (wt. %) | — | 3.90 | — | 3.92 | 7.71 |
| Total (wt. %) | 99.78 | 99.75 | 99.94 | 99.96 | 100.00 |
| Total Alkali Metal Oxides | 2.274 | 2.05 | 2.331 | 2.119 | 1.840 |

Composition in Mole Percentage (mol % on an oxide basis)

| | | | | | |
|---|---|---|---|---|---|
| SiO₂ (mol %) | 50.1 | 46.3 | 52.2 | 48.1 | 44.3 |
| Al₂O₃ (mol %) | 14.2 | 13.2 | 13.5 | 12.6 | 11.7 |
| Iron Oxides (mol %) | 9.5 | 8.8 | 10.7 | 9.9 | 9.1 |
| K₂O (mol %) | 0.2 | 0.1 | 0.4 | 0.3 | 0.3 |
| Na₂O (mol %) | 2.5 | 2.2 | 2.2 | 2.0 | 1.8 |
| MgO (mol %) | 6.4 | 5.9 | 7.6 | 6.9 | 6.3 |
| TiO₂ (mol %) | 0.7 | 0.7 | 2.0 | 1.9 | 1.7 |
| MnO₂ (mol %) | 0.5 | 0.5 | 0.5 | 0.5 | 0.4 |
| CaO (mol %) | 15.9 | 18.3 | 10.8 | 13.5 | 16.4 |
| B₂O₃ (mol %) | — | 4.1 | — | 4.2 | 8.1 |
| Total (mol %) | 100.0 | 100.1 | 100.0 | 99.9 | 100.1 |
| Total Alkali Metal Oxides | 2.7 | 2.3 | 2.6 | 2.3 | 2.1 |

Properties

| | | | | | |
|---|---|---|---|---|---|
| T_{g} (° C.) | 680.6 | 647.5 | 684.4 | 647.2 | 635.0 |
| Tₓ (° C.) | 860.7 | 827.7 | 831.5 | 812.5 | 809.8 |
| T_{x, peak} (° C.) | 881.3 | 843.4 | 870.3 | 870.1 | 825.1 |
| (Tₓ − T_{g}) (° C.) | 180 | 180 | 147 | 165 | 175 |
| Tₘ (° C.) | — | — | — | — | — |
| T_{L} (° C.) | — | — | — | — | — |
| T_{S} (° C.) | 647 | 614 | 568 | 617 | 599 |
| T_{A} (° C.) | 684 | 651 | 602 | 654 | 636 |
| (T_{A} − T_{S}) (° C.) | 37 | 37 | 34 | 37 | 37 |
| Shear modulus (GPa) | 39.9 | 38.2 | 40.092 | 39.218 | 37.48 |
| Young's modulus (GPa) | 101 | 97 | 100 | 99 | 95 |
| Bulk modulus (GPa) | 69.8 | 69.6 | 67.8 | 67.6 | 68.3 |
| Poisson's ratio | 0.26 | 0.268 | 0.253 | 0.257 | 0.268 |
| Density (g/cm³) | 2.956 | 2.931 | 2.967 | 2.944 | 2.923 |
| SP mod | 34.0 | 33.1 | 33.9 | 33.5 | 32.5 |

| | 7 | E | F | G |
|---|---|---|---|---|
| Type of Composition | Basalt + | E-Glass | S-Glass | R-Glass |
| | Colemanite | | | |
| Basalt Source | Hawaii 5 | N/A | N/A | N/A |
| Colemanite (wt. %) | 7.5 | — | — | — |
| SiO₂ (wt. %) | 37.91 | — | — | — |
| Al₂O₃ (wt. %) | 11.846 | — | — | — |
| Iron Oxides (wt. %) | 23.633 | — | — | — |
| K₂O (wt. %) | 0.25 | — | — | — |
| Na₂O (wt. %) | 1.108 | — | — | — |
| MgO (wt. %) | 11.203 | — | — | — |
| TiO₂ (wt. %) | 1.47 | — | — | — |
| MnO₂ (wt. %) | 0.582 | — | — | — |
| CaO (wt. %) | 8.104 | — | — | — |
| B₂O₃ (wt. %) | 4.00 | — | — | — |
| Total (wt. %) | 100.1 | — | — | — |
| Total Alkali Metal Oxides | 1.358 | — | — | — |
| SiO₂ (mol %) | 44.4 | 58.4 | 68.7 | 64.1 |
| Al₂O₃ (mol %) | 8.2 | 8.5 | 15.6 | 15.7 |
| Iron Oxides (mol %) | 10.4 | — | — | — |
| K₂O (mol %) | 0.3 | — | — | — |
| Na₂O (mol %) | 1.3 | — | — | — |
| MgO (mol %) | 19.7 | 6.9 | 15.8 | 9.7 |
| TiO₂ (mol %) | 1.3 | — | — | — |
| MnO₂ (mol %) | 0.5 | — | — | — |
| CaO (mol %) | 10.2 | 19.9 | — | 10.5 |
| B₂O₃ (mol %) | 4.0 | 6.7 | — | — |
| Total (mol %) | 100.3 | 100.5 | 100.1 | 100.0 |
| Total Alkali Metal Oxides | 1.6 | — | — | — |
| T_{g} (° C.) | 648.2 | 698.6 | 812.2 | 800.1 |
| Tₓ (° C.) | 786.6 | 915.0 | 984.6 | 945.8 |
| T_{x, peak} (° C.) | 798.0 | — | — | — |
| (Tₓ − T_{g}) (° C.) | 138 | 216.4 | 172.4 | 145.7 |
| Tₘ (° C.) | — | — | — | — |
| T_{L} (° C.) | — | — | — | — |
| T_{S} (° C.) | 616 | 644 | 779 | 753 |
| T_{A} (° C.) | 651 | 687 | 822 | 798 |
| (T_{A} − T_{S}) (° C.) | 35 | 43 | 43 | 45 |
| Shear modulus (GPa) | 41.617 | 34.3 | 38.0 | 37.2 |
| Young's modulus (GPa) | 106 | 85.6 | 93.6 | 92.2 |
| Bulk modulus (GPa) | 76.2 | 56.2 | 58.0 | 58.9 |
| Poisson's ratio | 0.269 | 0.25 | 0.23 | 0.24 |
| Density (g/cm³) | 3.033 | 2.585 | 2.492 | 2.560 |
| SP mod | 34.8 | 33.1 | 37.6 | 36.0 |

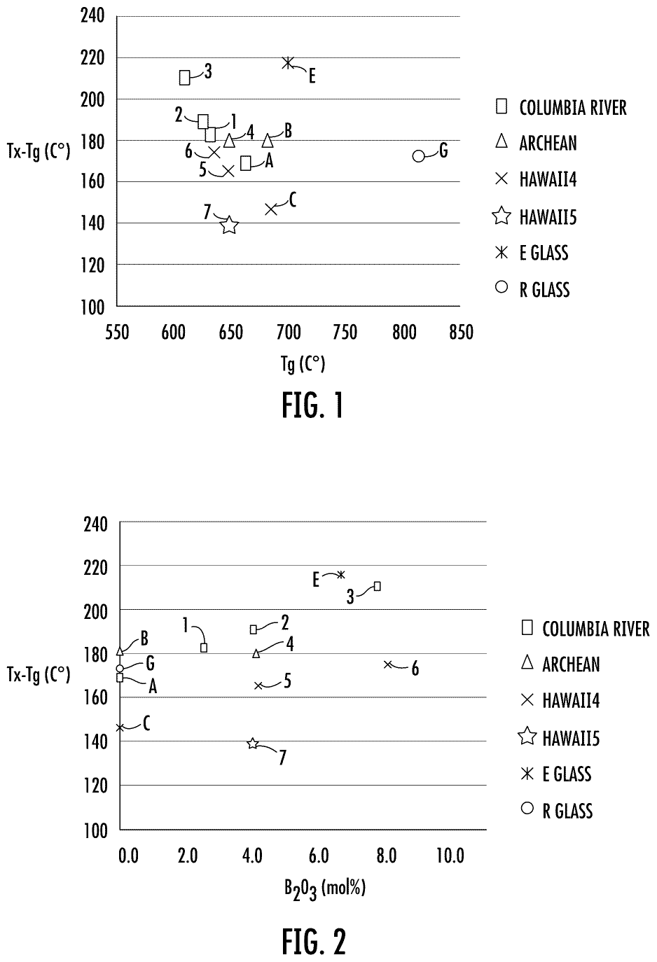

Referring now to FIG. 1, the (Tₓ-T_{g}) as a function of glass transition temperature (T_{g}) for the compositions of Examples 1-7 and Comparative Examples A, B, C, E, and G are graphically shown. In FIG. 1, a greater (Tₓ-T_{g}) indicates that the melt produced from the batch composition should be more stable, which means that the batch composition can be melted to form the melt with reduced risk of crystallization during fiber formation. As shown in FIG. 1, the (Tₓ-T_{g}) of the compositions of Examples 1-7 made from batch compositions comprising the basalt and colemanite are similar to current production glasses Comparative Examples E and G (i.e., E-glass and R-glass, respectively), meaning that the compositions of Examples 1-7 should have stabilities similar to that of the E-glass and R-glass compositions of Comparative Examples E and G. FIG. 1 also shows that the compositions of Examples 1-7 have a lower glass transition temperature compared to the E-glass and R-Glass, implicating a lower temperature-viscosity curve, which is expected to provide improved melting and fiber formation and greater thermal efficiency of the fiber production process.

Referring now to FIG. 2, the (Tₓ-T_{g}) as a function of the B₂O₃ content of the composition for each of the compositions of Examples 1-7 and Comparative Examples A, B, C, E, and G are graphically shown. For each of the different basalt sources (i.e., Columbia River, Archean, Hawaii 4), the (Tₓ-T_{g}) generally increases with increasing B₂O₃ content, which indicates that the stability of the batch composition and melt produced therefrom also increases with increasing B₂O₃ content in the composition.

Referring now to FIG. 3, the Young's modulus as a function of (Tₓ-T_{g}) for each of the compositions of Examples 1-7 and Comparative Examples A, B, C, E, and G are graphically shown. FIG. 3 indicates an inverse relationship between the Young's modulus and the glass stability (i.e., (Tₓ-T_{g})). As the (Tₓ-T_{g}) increases, the Young's modulus decreases, which is true for the production glasses (E glass and R glass of Comparative Examples E and G) and the compositions prepared from the Columbia River, Hawaii 4, and Hawaii 5 basalts. The notable exception was the batch compositions prepared with the Archean basalts (i.e., Comparative Example B and Example 4), which exhibited a moderate Tₓ-T_{g} and the greatest Young's modulus.

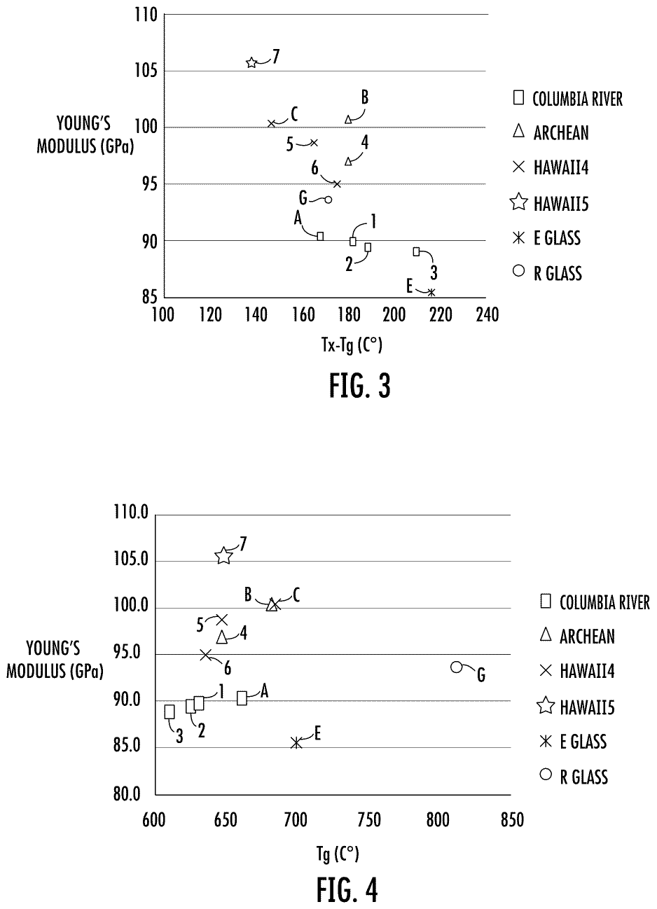

Referring now to FIG. 4, the Young's modulus as a function of glass transition temperature T_{g} for each of the compositions of Examples 1-7 and Comparative Examples A, B, C, E, and G is graphically depicted. As shown in FIG. 4, the Young's modulus of the compositions of Examples 1-7 are relatively high, which indicates that the continuous basalt fibers made therefrom are suitable for fiberglass applications. The glass transition temperatures Tg of the compositions of Examples 1-7 are relatively low compared to the current production glass fibers (i.e., the E-glass and R-glass of Comparative Examples E and G, respectively), which makes the compositions of Examples 1-7 easier to melt and form compared to the E-glass and R-glass.

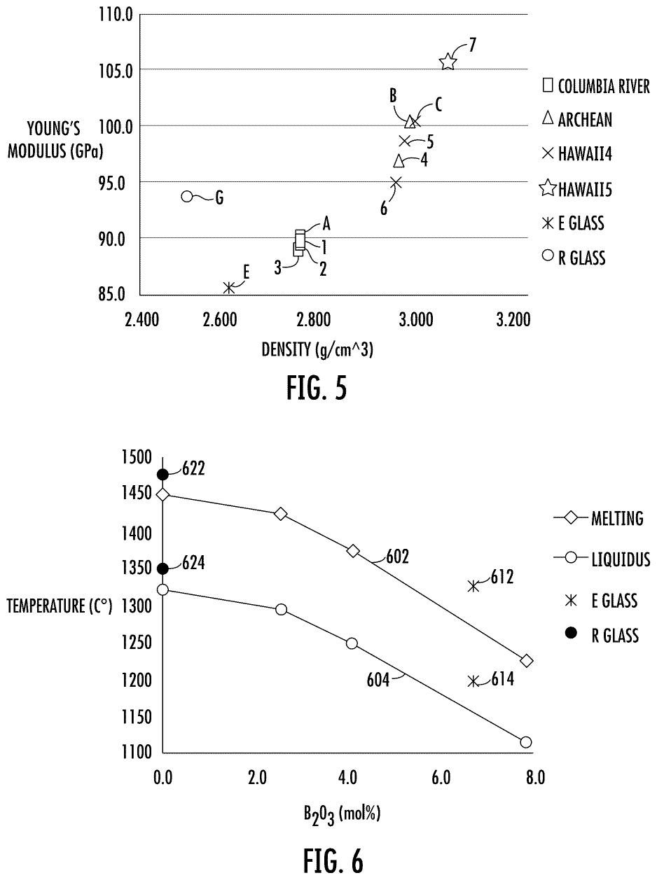

Referring now to FIG. 5, the Young's modulus as a function of density for each of the compositions of Examples 1-7 and Comparative Examples A, B, C, E, and G is graphically depicted. As shown in FIG. 5, the Young's modulus increases with increasing density. Referring now to FIG. 6, the liquidus temperature and melting temperature as functions of B₂O₃ content for the compositions comprising the Columbia River basalt (i.e., Comparative Example A and Examples 1-3) and for the compositions of Comparative Examples E and G are graphically depicted. In FIG. 6, reference number 602 indicates the melt temperature and reference number 604 indicates the liquidus temperature for the compositions of Comparative Example A and Examples 1-3, which were made with the Columbia River basalt. As shown in FIG. 6, increasing the B₂O₃ content in the compositions, such as by increasing the colemanite or individual B₂O₃ and/or CaO precursors added to the basalt, reduces the melt temperature and the liquidus temperature of the batch compositions. For comparison purposes, FIG. 6 also includes the melt temperature (612) and liquidus temperature (614) for the E-glass of Comparative Example E and the melt temperature (622) and liquidus temperature (624) for the R-glass of Comparative Example G. As shown in FIG. 6, the compositions made with the Columbia River basalt have lower melt and liquidus temperatures compared to the E-glass and R-glass, while still providing sufficient mechanical properties, such as Young's modulus of greater than 85 GPa (see FIG. 5), which is greater than the Young's modulus of the E-glass of Comparative Example E.

The compositions of Examples 1 and 3 were each separately formed into continuous basalt fibers. The continuous basalt fibers for Examples 1 and 3 were prepared by adding the batch composition to a crucible contained within a furnace and heating the batch composition to a forming temperature, which is a temperature greater than or equal to the melt temperature and less than the crystallization temperature (i.e., temperature at which the onset of crystallization occurs) to form a homogeneous melt. The melt is then continuously pulled from a hole in the bottom of the crucible and cooled to produce the continuous basalt fibers. The continuous basalt fibers where then tested for Young's modulus and tensile strength according to the test methods provided herein. The Young's modulus and tensile strength of the continuous basalt fibers are provided in Table 2.

TABLE 2

| Parameter | Example 1 | Example 3 |
|---|---|---|
| Amount of colemanite | 5 | 20 |
| (wt. %) | | |
| B₂O₃ Content (mol % on | 2.5 | 7.8 |
| an oxide basis) | | |
| Young's modulus (GPa) | 80-90 | 82-91 |
| Tensile strength (MPa) | 1163 | 1079 |

While various aspects of the compositions, continuous basalt fibers, batch compositions, and methods have been described herein, it should be understood that it is contemplated that each of these aspects and techniques may be used separately or in conjunction with one or more aspects and techniques.

It will be apparent to those skilled in the art that various modifications and variations can be made to the aspects described herein without departing from the spirit and scope of the claimed subject matter. Thus it is intended that the specification cover the modifications and variations of the various aspects described herein provided such modification and variations come within the scope of the appended claims and their equivalents.

What is claimed is:

1. A composition comprising:
from 35 wt. % to 60 wt. % SiO₂;
from 7 wt. % to 20 wt. % Al₂O₃;
from 7 wt. % to 24 wt. % iron oxides;
from 8 wt. % to 20 wt. % CaO;
from 1 wt. % to 5 wt. % alkali metal oxides; and
from 0.5 wt. % to 12 wt. % B₂O₃, wherein the weight percentages are based on the total weight of the composition.

2. The composition of claim 1, further comprising:
from 2 wt. % to 20 wt. % MgO based on the total weight of the composition;
from 0.1 wt. % to 3 wt. % TiO₂ based on the total weight of the composition;
from 0.1 wt. % to 1 wt. % MnO₂ based on the total weight of the composition; or
combinations thereof.

3. The composition of claim 1, wherein:
the iron oxides include FeO, Fe₂O₃, or both; and
the alkali metal oxides comprise Na₂O, K₂O, or both.

4. The composition of claim 1, wherein the composition has at least one of a melt temperature of from 1200° C. to less than 1500° C., a glass transition temperature of from 600° C. to 700° C., a density of from 2.7 g/cm³ to 3.2 g/cm³, or combinations thereof.

5. The composition of claim 1, wherein the composition has a difference between a glass transition temperature and a crystallization temperature of from 100° C. to 220° C., where the crystallization temperature refers to the temperature at which crystallization of the composition begins as measured by differential scanning calorimetry (DSC).

6. The composition of claim 1, wherein the composition comprises:
from 36 wt. % to 52.0 wt. % SiO₂;
from 11.5 wt. % to 18.5 wt. % Al₂O₃;
from 7.5 wt. % to 20 wt. % iron oxides;
from 3 wt. % to 8 wt. % MgO;
from 0.5 wt. % to 2 wt. % TiO₂;
from 10 wt. % to 15 wt. % CaO;
from 1.8 wt. % to 4.2 wt. % alkali metal oxides; and
from 2 wt. % to 9 wt. % B₂O₃, wherein the weight percentages are based on the total weight of the composition.

7. The composition of claim 1, comprising:
from 44 mol % to 60 mol % SiO₂;
from 7 mol % to 15 mol % Al₂O₃;
from 3 mol % to 11 mol % iron oxides;
from 10 mol % to 20 mol % CaO;
from 1 mol % to 5 mol % alkali metal oxides; and
from 0.5 mol % to 12 mol % B₂O₃, wherein the mole percentages are based on a total moles of oxides in the composition.

8. The composition of claim 1, further comprising from 1 ppbw to 5 ppmw uranium, from 1 ppbw to 5 ppmw thorium, or both.

9. The composition of claim 1, wherein the composition is in the form of a continuous basalt fiber.

10. The composition of claim 9, wherein the continuous basalt fiber has one or more of the following:
a Young's Modulus of greater than or equal to 85 GPa;
a tensile strength of greater than or equal to 1000 MPa;
a Shear Modulus of greater than or equal to 35 GPa; or
combinations thereof.

11. The composition of claim 9, wherein the continuous basalt fiber has a Young's modulus that is within 10 GPa of a Young's modulus of a comparative basalt fiber made with basalt only with no added colemanite or other constituents, wherein a basalt used to make the continuous basalt fiber and the basalt used to make the comparative basalt fiber are from the same source.

12. The composition of claim 9, wherein the continuous basalt fiber has a melt temperature that is at least 20° C. less than a melt temperature of a comparative basalt fiber made with basalt only with no added colemanite or other constituents, wherein a basalt used to make the continuous basalt fiber and the basalt used to make the comparative basalt fiber are from the same source.

13. The composition of claim 9, wherein the continuous basalt fiber has a glass transition temperature that is at least 20° C. less than a glass transition temperature of a comparative basalt fiber made with basalt only with no added colemanite or other constituents, wherein a basalt used to make the continuous basalt fiber and the basalt used to make the comparative basalt fiber are from the same source.

14. An article comprising the continuous basalt fibers of claim 9.

15. The article of claim 14, wherein the article comprises a hard disk substrate, a wind turbine blade, a pressurized tank, a building material, insulation, an aircraft structure, a spacecraft structure, electronics packaging, or sporting goods.

16. The composition of claim 1, wherein the composition comprises a batch composition.

17. The composition of claim 16, wherein the batch composition comprises from 75 wt. % to 99.5 wt. % basalt and from 0.5 wt. % to 25 wt. % colemanite, based on the total weight of the composition.

18. A method of making a continuous basalt fiber, the method comprising combining from 75 wt. % to 99.5 wt. % basalt with from 0.5 wt. % to 25 wt. % colemanite to produce a batch composition; heating the batch composition to a forming temperature of from 1200° C. to 1400° C. to produce a melt; drawing a continuous strand from the melt; and cooling the continuous strand to produce the continuous basalt fiber.

19. The method of claim 18, wherein the batch composition comprises: from 35 wt. % to 60 wt. % SiO₂; from 7 wt. % to 20 wt. % Al₂O₃; from 7 wt. % to 24 wt. % iron oxides; from 8 wt. % to 20 wt. % CaO; from 1 wt. % to 5 wt. % alkali metal oxides; and from 0.5 wt. % to 12 wt. % B₂O₃, wherein the weight percentages are based on the total weight of the composition.

20. A continuous basalt fiber produced from the method of claim 18.
